(19) United States
(12) Patent Application Publication
(10) Pub. No.: US 2008/0177056 A1
(43) Pub. Date: Jul. 24, 2008

(54) Method for Producing Cellulose Acylate Film and Cellulose Acylate Pellet

(75) Inventors: Kiyokazu Hashimoto, Kanagawa (JP); Masaaki Otoshi, Shizuoka (JP)

Correspondence Address: BUCHANAN, INGERSOLL & ROONEY PC, POST OFFICE BOX 1404, ALEXANDRIA, VA, 22313-1404, US

(73) Assignee: Fuji Photo Film Co., Ltd., Minami-ashigara-shi, Kanagawa (JP)

(21) Appl. No.: 11/587,403

(22) PCT Filed: Apr. 25, 2005
(86) PCT No.: PCT/JP2005/008323

§ 371 Date: Aug. 16, 2007

(30) Foreign Application Priority Data
Apr. 26, 2004 (JP) 2004-129403

(51) Int. Cl. C08B 15/00; B29B 9/06; B29C 47/76; B29C 47/88

(52) U.S. Cl. 536/56; 264/143; 264/102; 264/211.11

(57) ABSTRACT

Provided is a cellulose acylate film formed through melt casting that is capable of being built in liquid-crystal display devices to solve the display trouble at the time of black level of display. That is a cellulose acylate film formed through melt casting, in which the number of polarizing minor impurities is from 0 to 10/mm² and the number of black impurities is from 0 to 10/mm², and which has a transmittance at 450 nm (T450) of from 90 to 100%.

### TECHNICAL FIELD

The present invention relates to a novel cellulose acylate film, and to a method for producing cellulose acylate pellets suitable as a material for the cellulose acylate film.

### BACKGROUND ART

Heretofore, in producing cellulose acylate films for use in liquid-crystal image display devices, etc., a solution casting method has been principally carried out, which comprises dissolving a polymer in a chlorine-containing organic solvent such as dichloromethane, casting it on a substrate, and drying it to form a film. Dichloromethane, a type of a chlorine-containing organic solvent has been favorably used as a solvent for cellulose acylate. One reason for it is that the solvent has a low boiling point (about 40° C.) and is therefore readily dried away in the production step, the film formation step and the drying step.

Recently, however, from the viewpoint of environmental protection, the chlorine-containing organic solvent has become required to be severely handled in a closed system. Specifically, the leakage of the solvent must be surely reduced, and some countermeasure must be taken for an emergency of its leakage. In that situation, there are known a method of providing a gas absorption tower so as to adsorb and treat a chlorine-containing organic solvent before its discharging; and a method of burning a gas by a power of fire or decomposing a chlorine-containing organic solvent with electronic beams before its discharging. As a result, the organic solvent is not almost discharged out, but further studies are required for its complete non-discharging.

As a method of film formation with no use of a chlorine-containing organic solvent, JP-A-2000-352620 discloses a method of melt film formation of cellulose acylate. JP-A-2000-352620 says that the carbon chain of the ester group in cellulose acylate is prolonged so as to lower the melting point of the polymer for easy melt film formation of the polymer. Concretely, it describes changing cellulose acetate into cellulose propionate.

We, the present inventors tried forming a polarizer, using a film produced according to the melt film formation method described in JP-A-2000-352620, and tried building the polarizer in liquid-crystal display devices, but there occurred a display trouble at the time of black level of display. Specifically, we experienced light leakage from a site that should be naturally true black to have only gray display in that site. In addition, the method described in JP-A-2000-352620 has another problem in that the films produced have many black impurities and are much yellowed. This is because, in the method described in the patent publication, the impurities are removed through precision filtration to a degree of at most 50 μm, preferably at most 5 μm in melt, and therefore the resin having remained in the dead space in a filtration device may be thermally decomposed to be yellowed further more or carbonized into black impurities. The thermal decomposition is noticeable in processing cellulose acylate resin.

### DISCLOSURE OF THE INVENTION

The invention is to solve the above-mentioned problems, and to provide a cellulose acylate film formed through melt casting, that is capable of being built in liquid-crystal display devices to solve the display trouble at the time of black level of display.

(1) A cellulose acylate film formed through melt casting, in which the number of polarizing minor impurities is from 0 to 10/mm² and the number of black impurities is from 0 to 10/mm², and which has a transmittance at 450 nm (T450) of from 90 to 100%.

(2) The cellulose acylate film of claim 1, in which the number of polarizing minor impurities is from 0 to 8/mm² and the number of black impurities is from 0 to 8/mm², and which has a transmittance at 450 nm (T450) of from 91 to 99%.

(3) The cellulose acylate film of (1) or (2), which has Rth of from 100 to 800 nm.

(4) The cellulose acylate film of (1) or (2), which has Rth of from 140 to 500 nm.

(5) The cellulose acylate film of any of (1) to (4), wherein the acyl group that the cellulose acylate film has satisfies all the requirements of the following formulae (1) to (3):

2.6≦X+Y<3.0, (1)

0≦X≦1.8, (2)

1.0≦Y<3; (3)

wherein, in the above formulae (1) to (3), X means a substitution degree for an acetyl group; Y means a total substitution degree for a propionyl group, a butyryl group, a pentanoyl group and a hexanoyl group.

(6) The cellulose acylate film of any of (1) to (4), wherein the acyl group that the cellulose acylate film has satisfies all the requirements of the following formulae (1) to (3): when at least ½ of the following Y is a propionyl group,

2.6≦X+Y≦2.95, (4)

0≦X≦0.95, (5)

1.5≦Y≦2.95; (6)

when less than ½ of the following Y is a propionyl group,

2.6≦X+Y≦2.95, (7)

0.1≦X≦1.65, (8)

1.3≦Y≦2.5; (9)

wherein, in the above formulae (4) to (9), X means a substitution degree for an acetyl group; Y means a total substitution degree for a propionyl group, a butyryl group, a pentanoyl group and a hexanoyl group.

(7) The cellulose acylate film of any of (1) to (6), which has Re of from 20 to 300 nm.

(8) The cellulose acylate film of any of (1) to (6), which has Re of from 30 to 250 nm.

(9) A cellulose acylate film, which is produced by stretching the cellulose acylate film of any of (1) to (8), by from 10 to 300% in at least one direction thereof.

(10) The cellulose acylate film of any of (1) to (9), which has a total light transmittance of at least 80%.

(11) A method for producing cellulose acylate pellets, which comprises kneading and melting a cellulose acylate-containing composition in a kneading extruder, at from 150 to 220° C., at a screw revolution of from 100 to 800 rpm, for a residence time of from 5 seconds to 3 minutes.

(12) The method for producing cellulose acylate pellets of (11), wherein the cellulose acylate satisfies all the requirements of the following formulae (1) to (3):

2.6≦X+Y<3.0, (1)

0≦X≦1.8, (2)

1.0≦Y<3; (3)

wherein, in the above formulae (1) to (3), X means a substitution degree for an acetyl group; Y means a total substitution degree for a propionyl group, a butyryl group, a pentanoyl group and a hexanoyl group.

(13) The method for producing cellulose acylate pellets of (11) or (12), wherein the composition is kneaded and melted in vacuum degasification.

(14) The method for producing cellulose acylate pellets of any of (11) to (13), wherein, after melted, the composition is solidified in strands in warm water at 30 to 90° C., and then cut and dried.

(15) Cellulose acylate pellets produced according to the method of any of (11) to (14).

(16) Cellulose acylate pellets which satisfy all the requirements of the following formulae (1) to (3) and in which the number of polarizing minor impurities is from 0 to 100/mm³:

2.6≦X+Y<3.0, (1)

0≦X≦1.8, (2)

1.0≦Y<3; (3)

wherein, in the above formulae (1) to (3), X means a substitution degree for an acetyl group; Y means a total substitution degree for a propionyl group, a butyryl group, a pentanoyl group and a hexanoyl group.

(17) A method for producing a cellulose acylate film, which comprises melting the cellulose acylate pellets produced according to the method of any of (11) to (14), extruding the melt through a die and forming it into a film having a predetermined thickness on a casting drum, and in which the film formation is so planned that the ratio of the lip distance T of the die to the formed film thickness D (T/D) could be from 2 to 10.

(18) A polarizer having a polarizing layer, and, as provided on the polarizing layer, at least one layer of the cellulose acylate film of any of (1) to (10).

(19) An optical compensatory film for liquid-crystal display panels, which comprises the cellulose acylate film of any of (1) to (10) as the substrate thereof.

(20) An antireflection film, which comprises the cellulose acylate film of any of (1) to (10) as the substrate thereof.

### DETAILED DESCRIPTION OF THE INVENTION

The contents of the invention are described in detail hereinunder. In this description, the numerical range expressed by the wording “a number to another number” means the range that falls between the former number indicating the lowermost limit of the range and the latter number indicating the uppermost limit thereof.

We, the present inventors analyzed the cause of the display trouble that may occur at the time of black level of display when the above-mentioned polarizer is built in liquid-crystal display devices, or that is, the gray display trouble at the site that should be naturally true black, and have known that the trouble is caused by light leakage from minor impurities and by light leakage in the oblique direction of liquid-crystal display devices.

(Light Leakage from Polarizing Minor Impurities)

We have known that there exist polarizing minor impurities which could be seen only with a polarization microscope, and slight light may leak out from them to cause the gray display trouble at the site to be in black display. These minor impurities could not be detected with the naked eye and therefore would not be an impurities-caused trouble, but they cause slight light leakage, therefore causing the above-mentioned display trouble. Since the light leakage is minor, it could not be recognized except the case of black level of display where all light is shut off. Regarding their size, the polarizing minor impurities have a diameter of from 1 to 100 μm, and they could be observed with a polarization microscope under a cross-Nicol condition. Preferably, the number of such impurities is from 0 to 10/mm², more preferably from 0 to 8/mm², even more preferably from 0 to 5/mm². The diameter as referred to herein means a circle-corresponding diameter of the impurities. That is, it means a diameter of the circle having the same area as that of the impurity.

### (Light Leakage in the Oblique Direction of Liquid-Crystal Display Devices)

In a melt film formation method, a film is immediately solidified while its alignment is completely lost as being melted, and therefore, the in-plane alignment of the film hardly goes on. As opposed to it, in conventional solution film formation, a film is formed while the solvent is evaporated away, and therefore the film is compressed in the thickness direction thereof and its in-plane alignment may smoothly go on. Accordingly, as compared with a film formed through solution casting, a film formed through melt casting could hardly express a retardation (Rth), which is represented by the following formula and which is an index of in-plane alignment of the film, and its Rth could reach at most 80 nm.

Rth=|{(n_{md}, ₁+n_{td})/2}−nₜₕ|×d

wherein n_{md}, n_{td}, and nₜₕ each indicate the refractive index of the film in the machine direction (md), in the transverse direction (TD) and in the thickness direction (th), respectively; and d indicates the thickness of the film (as a unit of nm).

Since Rth is the refractivity anisotropy in the thickness direction, the effect of Rth is remarkable when a film is seen in the oblique direction thereof. Specifically, in case where such a film is built in liquid-crystal display devices, the devices are planned in accordance with the optical properties of the conventional film formed through solution casting having a large Rth. Therefore, when a film formed through solution casting having a small Rth is used, then there may occur light leakage in the oblique direction thereof.

Accordingly, Rth of a film formed through melt casting is preferably from 100 nm to 800 nm, more preferably from 140 nm to 500 nm, even more preferably from 160 nm to 350 nm.

### (Black Impurities, Yellowing)

Black impurities are impurities that look black in direct observation with no use of polarizer (since they are black and they could not be seen when sandwiched between polarizers that are perpendicular to each other, they differ from the above-mentioned luminescent point impurities). These black impurities are caused by thermal decomposition and carbonization of resin, and therefore they are often formed in a filtration device or the like in which the residence time is long and which has a large dead space. The black impurities are, for example, those having a diameter of from 1 to 100 μm and capable of being observed with a transmission microscope (in ordinary observation with no use of polarization). In the invention, the number of such black impurities is preferably from 0 to 10/mm², more preferably from 0 to 8/mm², even more preferably from 0 to 5/mm². The diameter as referred to herein indicates a circle-corresponding diameter. That is, it indicates a diameter of the circle having the same area as that of the impurity.

On the other hand, yellowing may be indicated by the light transmittance of a formed film measured at 450 nm (T450) and calculated in terms of the film thickness of 100 μm. That is, it may be indicated by the light transmittance with blue (450 nm) that is a complementary color of yellow. The cause of yellowing is also thermal decomposition owing to the residence in a filtration device. Preferably, T450 is from 90% to 100%, more preferably from 91% to 99%, even more preferably from 92% to 98%.

The invention has solved the problems with the polarizing minor impurities and the low Rth mentioned above, in the manner mentioned below.

### (1) Reduction in Polarizing Minor Impurities, Black Impurities, Yellowing:

Polarizing minor impurities do not exist in cellulose acylate films formed in a solution casting method, but exist only in films formed in a melt film formation method. We analyzed the cause of their occurrence and have found that the impurities are the unreacted substances in production of cellulose acylate. Specifically, cellulose acylate is prepared through acylation of cellulose, in which, however, cellulose acylate having a low degree of acylation may be formed owing to non-uniform acylation. In a solution film formation method, the low-acylation substance may dissolve in a solvent, therefore not causing polarizing minor impurities. However, in a conventional melt film formation method, the low-acylation substance could not be melted but would remain as minor impurities, therefore forming the above-mentioned polarizing minor impurities.

The invention is characterized in that the formation of such polarizing minor impurities is prevented by specifically planning the step of pelletization of cellulose acylate. Such minor impurities could not be completely removed away through filtration, and the invention is characterized in that it has basically solved the problem (by fully melting the low-acylation substance that may form polarizing minor impurities). The invention does not require a filtration device for removing minor impurities in the pelletization step before the filtration step, and a simple metal-mesh filter may be enough for it. As a result, black impurities and yellowing to be caused by thermal decomposition in a filtration device may be reduced.

Concretely, using a double-screw kneading extruder, cellulose acylate pellets may be formed at a temperature of preferably from 150 to 220° C., more preferably from 160 to 210° C., even more preferably from 170 to 200° C., at a screw revolution of preferably from 100 to 800 rpm, more preferably from 150 to 600 rpm, even more preferably from 200 to 400 rpm, for a residence time of preferably from 5 seconds to 3 minutes, more preferably from 10 seconds to 2minutes, even more preferably from 20 seconds to 90 seconds.

The compression ratio of the screw to be used is preferably from 2 to 5, more preferably from 2.5 to 4.5, even more preferably from 2.5 to 4. The diameter of the barrel through which the screw runs is preferably from 10 mm to 100 mm, more preferably from 15 mm to 80 mm, even more preferably from 20 mm to 60 mm. The ratio of the length (L) to the diameter (D) of the barrel (L/D) is preferably from 20 to 100, more preferably from 25 to 80, even more preferably from 25 to 60. The resin extrusion rate is preferably from 50 kg/hr to 1000 kg/hr, more preferably from 70 kg/hr to 800 kg/hr, even more preferably from 80 kg/hr to 600 kg/hr.

In a conventional pelletization step, a double-screw kneading extruder is used at a temperature of from 250 to 330° C. or higher than it, at a screw revolution of from 10 to 50 rpm or lower than it, for a residence time of from 5 minutes to 15 minutes or longer than it. That is, resin is slowly pelletized at a high temperature with no shear force applied thereto (at a low revolution).

As opposed to it, in the invention, resin is preferably pelletized at a low temperature for a short period of time and at a high shear force (high revolution). Employing the method is more effective for melting a low-acetylation substance. Specifically, in the conventional method where resin is melted by heat (high temperature×long period of time) with no shear force applied thereto (at low revolution), the resin may be decomposed while melted and the crosslinking reaction to occur along with it may make the low-acetylation substance more hardly meltable. As opposed to it, in the invention where resin is melted not by heat (low temperature×short period of time) but by shear force (at high revolution), neither decomposition nor crosslinking occurs and therefore a low-acetylation substance may be effectively melted.

Further in the invention, it is desirable that a vent is provided on the outlet port side of the double-screw extruder to be used, via which the extruder is degassed in vacuum in producing pellets.

In pelletization of cellulose acylate, in general, the polymer is previously fully pre-dried (at 80° C. to 150° C., for 0.1 hours to 24 hours). However, since cellulose acylate powder is hydrophilic and since about 0.2% by mass of residual water may remain therein, the decomposition of the low-acetylation substance therein may be promoted by the presence of water in the polymer, therefore often forming crosslinking impurities. Accordingly, in the invention, it is desirable that, in addition to such pre-drying, a vent is provided in the double-screw kneading extruder for pelletization, via which the extruder is degassed in vacuum during pelletization. The degree of vacuum at the vent is preferably from 100 Pa to 90 kPa, more preferably from 1000 Pa to 80 kPa, even more preferably from 10 kPa to 70 kPa. The vacuum degasification may be attained by providing an exhaust port through the casing of the screw of the double-screw extruder, and connecting it to a vacuum pump via piping.

Also in the invention, the polymer melt may be solidified in strands in a hot water preferably at 30 to 90° C., more preferably at 35 to 80° C., even more preferably at 37 to 60° C., then cut and dried.

In an ordinary process, after resin is melted in a double-screw kneading extruder, then extruded out into cold water at 5 to 20° C. through a die with a large number of holes of a few mm in size formed therein, thereby forming strands, and thereafter coagulated, then dewatered while being transported, and cut into pellets. In this stage, the temperature of water for coagulation is generally low as so mentioned above. This is because the modulus of elasticity of the strands could be kept as high as possible so that they are easy to transport.

As opposed to it, in the invention, the strands are preferably coagulated in hot water as above. A low-acylation substance contains many hydroxyl groups remaining therein, and therefore it may readily dissolve in water. Accordingly, by elevating the temperature of the coagulation bath as above, the dissolution of the substance is more effectively promoted. Further, the polarity of a thermally-decomposed substance is high and it may also readily dissolve in hot water, and therefore, the hot water bath is effective for reducing the substance and for preventing the polymer from yellowing. The dipping time in such hot water is preferably from 3 seconds to 10 minutes, more preferably from 5 seconds to 5 minutes, even more preferably from 10 seconds to 3 minutes.

After the coagulation bath, it is more desirable that the strands are led through cold water at from 5° C. to lower than 30° C. to thereby increase their elasticity and to further facilitate their transportation.

In the cellulose acylate pellets thus obtained in the manner as above, the number of polarizing minor impurities is greatly decreased. The number may be obtained according to the following method. The pellets are crushed with a hot press (at 220° C. for 1 minute), and formed into a sheet of about 100 μm in thickness. This is observed with a polarization microscope under a cross-Nicol condition, in which the number of the polarizing minor impurities is counted. From the thickness and the observed area of the sample, the number of the impurities per unit volume (mm³) is obtained. The polarizing minor impurities may have a diameter of from 1 to 100 μm, and it is desirable that the number of the impurities is from 0 to 100/mm³, more preferably from 0 to 80/mm³, even more preferably from 0 to 50/mm³.

### (2) Increase in Rth:

With the increase in Rth, it is desirable to employ at least one or more methods of the following (2-1) to (2-3).

### (2-1) T/D is Increased.

In melt film formation, in general, resin is melted, then extruded out through a slit, and solidified on a casting drum. In the invention, however, it is desirable that the resin is subjected to in-plain alignment on a casting drum so as to increase the Rth of the cast film. Specifically, it is desirable that the ratio of the lip distance (T) of the die to the thickness (D) of the formed film (T/D) is enlarged. Since the resin melt becomes thinner from the thickness of the lip distance T to D, the in-plane alignment of the film may go on during it. The ratio of T/D is preferably from 2 to 10, more preferably from 2.5 to 8, even more preferably from 3 to 6. In a conventional technique, T and D are set nearer to each other, and therefore T/D is almost 1.

For reducing the thickness from T to D, the following method may be employed.

The peripheral speed of the casting drum is enlarged, and the resin extruded out from the lip is taken on the casting drum (CD) rotating at such a high speed, whereby the thickness of the film formed may be reduced and the in-plane alignment thereof may be promoted. In this stage, the rotation speed of the casting drum is determined depending on the balance between the extrusion speed and the lip distance, and it is controlled to be the extrusion speed×(T/D). That is, the CD rotation speed is so planned that it could be T/D times the linear speed (V) of the resin at the extruder die outlet port.

### (2-2) The Distance Between the Die Lip and the Casting Drum is Controlled.

The distance between the die lip and the casting drum is preferably from 1 to 20% of the casting width. When the distance between the lip and the casting drum is set to be from 1 to 20% of the casting width, then it is desirable since the width of the film may be kept relatively wide and the thickness thereof may be relatively reduced. Concretely, the distance between the die lip and the casting drum is preferably from 1 to 20% of the casting width, more preferably from 2 to 15%, even more preferably from 3 to 10%. In a conventional technique of film formation, the distance is generally about 30%.

### (2-3) The Temperature at Both Edges of the Die is Kept Higher Than That at the Center Thereof.

When T/D is kept large and when the film is taken up at a high speed by increasing the peripheral speed of the casting drum, then the film may be stretched. On the casting drum on which the resin temperature lowers to about the glass transition temperature (Tg) of the resin, both edges of the film may be often cracked owing to such stretching operation. To prevent it, in the invention, the temperature at both edges of the die is kept higher than that in the center part thereof preferably by from 1 to 20° C., more preferably by from 2 to 15° C., even more preferably by from 3 to 12° C. Heating the edges of the die in that manner may be attained by additionally providing a panel heater around the die.

Increasing the T/D ratio and elevating the temperature at the edges of the die is more effective for reducing the polarizing minor impurities in the film. Specifically, when the in-plane alignment of the film is promoted at such a high T/D ratio as above, then the thickness of the film is compressed and the film expands in the transverse direction so as to absorb the compression with the result that the resin tends to flow from the center to the edges of the film. In this stage, when the temperature at the edges is high, then the flowability at the edges increases and therefore the resin flow from the center to the edges is promoted. With the resin flow, the polarizing minor impurities in the film may readily gather at the edges. Accordingly, the polarizing minor impurities may be more hardly exist in the center part of the film. On the other hand, the polarizing minor impurities are concentrated at the edges, but the edges may be trimmed away in the film formation step and in the subsequent stretching step with no further problem.

The invention is described below along the process of film formation.

### (Cellulose Acylate Resin)

The cellulose acylate to be used in the invention preferably has the following characteristics.

(1) Preferably, the acyl group in the cellulose acylate film satisfies all the requirements of the following formulae (1) to (3):

2.6≦X+Y<3.0, (1)

0≦X≦1.8, (2)

1.0≦Y<3; (3)

wherein, in the above formulae, X means a substitution degree for an acetyl group; Y means a total substitution degree for a propionyl group, a butyryl group, a pentanoyl group and a hexanoyl group.

More preferably,

when at least ½ of Y is a propionyl group,

2.6≦X+Y≦2.95, (4)

0≦X≦0.95, (5)

1.5≦Y≦2.95; (6)

when less than ½ of Y is a propionyl group,

2.6≦X+Y≦2.95, (7)

0.1≦X≦1.65, (8)

1.3≦Y≦2.5; (9)

even more preferably,
when at least ½ of Y is a propionyl group,

2.7≦X+Y≦2.95, (10)

0≦X≦1.55, (11)

2.0≦Y≦2.9; (12)

when less than ½ of Y is a propionyl group,

2.7≦X+Y≦2.95, (13)

0.7≦X≦1.65, (14)

1.3≦Y≦2.0; (15)

wherein, in the above formulae, X means a substitution degree for an acetyl group; Y means a total substitution degree for a propionyl group, a butyryl group, a pentanoyl group and a hexanoyl group.

The invention is characterized in that the substitution degree for an acetyl group is reduced and the total substitution degree for a propionyl group, a butyryl group, a pentanoyl group and a hexanoyl group is increased. Accordingly, stretching unevenness more hardly occurs during stretching of the film, and Re and Rth unevenness also more hardly occurs, and in addition, the crystal melting temperature (Tm, this may be referred to as a melting point) may be lowered with the result that the film may be prevented from being yellowed owing to the decomposition by heat in melt film formation. These effect may be attained by using a larger substituent, but if the substituent is too large, then it is unfavorable since Tg and the modulus of elasticity of the film may be lowered. Accordingly, a propionyl group, a butyryl group, a pentanoyl group and a hexanoyl group larger than an acetyl group are preferred, and a propionyl group and a butyryl group are more preferred.

The basic principle of the production of such cellulose acylate is described in Migita, et al., Wood Chemistry, pp. 180-190 (Kyoritsu Publishing, 1968). One typical production method is a liquid-phase acetylation method with a carboxylic acid anhydride-acetic acid-sulfuric acid catalyst. Concretely, a cellulose material such as cotton linter or wood pulp is pretreated with a suitable amount of acetic acid, then esterified by putting it into a previously-cooled carboxylation mixture liquid to thereby produce a complete cellulose acylate (the total of the degree of acylation at the 2-, 3- and 6-position thereof is almost 3.00). The carboxylation mixture liquid generally contains acetic acid serving as a solvent, a carboxylic acid anhydride serving as an esterifying agent and sulfuric acid serving as a catalyst. In general, the amount of the carboxylic acid anhydride is a stoichiometrically excessive amount over the total amount of the cellulose to be reacted with it and water existing in the system. After the acylation, the excessive carboxylic acid anhydride still remaining in the system is hydrolyzed and a part of the esterification catalyst is neutralized, for which an aqueous solution of a neutralizing agent (e.g., calcium, magnesium, iron, aluminium or zinc carbonate, acetate or oxide) is added to the system. Next, the obtained complete cellulose acylate is kept at 50 to 90° C. in the presence of a small amount of an acetylation catalyst (generally, this is the remaining sulfuric acid) to thereby saponify and ripen it into a cellulose acylate having a desired substitution degree for acyl group and a desired degree of polymerization. When the desired cellulose acylate is obtained, the catalyst still remaining in the system is completely neutralized with the above-mentioned neutralizing agent, or not neutralized, the cellulose acylate solution is put into water or diluted sulfuric acid (or water or diluted sulfuric acid is put into the cellulose acylate solution) to thereby separate the cellulose acylate, which is then washed and stabilized to be the intended cellulose acylate.

The degree of polymerization of the cellulose acylate preferably used in the invention is preferably from 100 to 700 in terms of the viscosity-average degree of polymerization thereof, more preferably from 100 to 500, even more preferably from 120 to 400, still more preferably from 140 to 350. The mean degree of polymerization may be measured according to an Uda et al's limiting viscosity method (Kazuo Uda, Hideo Saito; the Journal of the Society of Fiber Science and Technology of Japan, Vol. 18, No. 1, pp. 105-120, 1962). The method is described in detail in JP-A-9-95538.

Controlling the degree of polymerization may also be attained by removing a low-molecular weight component. When a low-molecular weight component is removed, then the mean molecular weight (degree of polymerization) may be high, but the viscosity may be lower than that of ordinary cellulose acylate. Therefore, the method is useful. The removal of a low-molecular component may be attained by washing cellulose acylate with a suitable organic solvent. Further, the molecular weight may also be controlled by a polymerization method. For example, when cellulose acylate having a reduced amount of a low-molecular component therein is produced, it is desirable that the amount of the sulfuric acid catalyst for use in acetylation is controlled to be from 0.5 to 25 parts by mass relative to 100 parts by mass of cellulose. When the amount of the sulfuric acid catalyst is within the above range, then cellulose acylate may be produced which is favorable in point of the molecular weight distribution thereof (having a uniform molecular weight distribution).

Preferably, the cellulose acylate to be used in the invention has a ratio of weigh-average molecular weight Mw/number-average molecular weight Mn of from 1.5 to 5.5, more preferably from 2.0 to 5.0, even more preferably from 2.5 to 5.0, most preferably from 3.0 to 5.0.

One or more different types of such cellulose acylate may be used herein. A mixture of cellulose acylate with any other polymer component than cellulose acylate may also be used herein. Preferably, the polymer component to be mixed is well compatible with cellulose ester, and also preferably, the transmittance of the film of the polymer is at least 80%, more preferably at least 90%, even more preferably at least 92%.

More preferably, a plasticizer is added in the invention. The plasticizer includes, for example, alkylphthalylalkyl glycolates, phosphates, carboxylates, polyalcohols (polyalcohol esters), polyalkylene glycols (polyalkylene glycol esters).

The alkylphthalylalkyl glycolates include, for example, methylphthalylmethyl glycolate, ethylphthalylethyl glycolate, propylphthalylpropyl glycolate, butylphthalylbutyl glycolate, octylphthalyloctyl glycolate, methylphthalylethyl glycolate, ethylphthalylmethyl glycolate, ethylphthalylpropyl glycolate, methylphthalylbutyl glycolate, ethylphthalylbutyl glycolate, butylphthalylmethyl glycolate, butylphthalylethyl glycolate, propylphthalylbutyl glycolate, butylphthalylpropyl glycolate, methylphthalyloctyl glycolate, ethylphthalyloctyl glycolate, octylphthalylmethyl glycolate, octylphthalylethyl glycolate.

The phosphates include, for example, triphenyl phosphate, tricresyl phosphate, biphenyldiphenyl phosphate. Further, the phosphate plasticizers described in JP-T-6-501040, claims 3-7 and pp. 6-7 are also preferably used herein.

The carboxylates include, for example, phthalates such as dimethyl phthalate, diethyl phthalate, dibutyl phthalate, dioctyl phthalate and di(ethylhexyl)phthalate; citrates such as acetyltrimethyl citrate, acetyltriethyl citrate, acetyltributyl citrate; as well as adipates such as dimethyl adipate, dibutyl adipate, diisobutyl adipate, bis(2-ethylhexyl)adipate, diisodecyl adipate and bis(butyl diglycoladipate). In addition, butyl oleate, methylacetyl ricinoleate, dibutyl sebacate and triacetin may also be used either singly or as combined with the above.

The polyalcohol plasticizers include glycerin-type ester compounds such as glycerin esters, diglycerin esters; polyalkylene glycols such as polyethylene glycol, polypropylene glycol; and compounds of polyalkylene glycols with an acyl group bonding to the hydroxyl group thereof, which are well compatible with cellulose fatty acid esters and which remarkably exhibit their thermo-plasticization effect.

Concretely, the glycerin esters include glycerin diacetate stearate, glycerin diacetate palmitate, glycerin diacetate myristate, glycerin diacetate laurate, glycerin diacetate caprate, glycerin diacetate nonanoate, glycerin diacetate octanoate, glycerin diacetate heptanoate, glycerin diacetate hexanoate, glycerin diacetate pentanoate, glycerin diacetate oleate, glycerin acetate dicaprate, glycerin acetate dinonanoate, glycerin acetate dioctanoate, glycerin acetate diheptanoate, glycerin acetate dicaproate, glycerin acetate divalerate, glycerin acetate dibutyrate, glycerin dipropionate caprate, glycerin dipropionate laurate, glycerin dipropionate myristate, glycerin dipropionate palmitate, glycerin dipropionate stearate, glycerin dipropionate oleate, glycerin tributyrate, glycerin tripentanoate, glycerin monopalmitate, glycerin monostearate, glycerin distearate, glycerin propionate laurate, glycerin oleate propionate, to which, however, the invention should not be limited. One or more of these may be used herein either singly or as combined.

Of the above, preferred are glycerin diacetate caprylate, glycerin diacetate pelargonate, glycerin diacetate caprate, glycerin diacetate laurate, glycerin diacetate myristate, glycerin diacetate palmitate, glycerin diacetate stearate, glycerin diacetate oleate.

Examples of the diglycerin esters are mixed acid esters of diglycerin and others, for example, diglycerin tetraacetate, diglycerin tetrapropionate, diglycerin tetrabutyrate, diglycerin tetravalerate, diglycerin tetrahexanoate, diglycerin tetraheptanoate, diglycerin tetracaprylate, diglycerin tetrapelargonate, diglycerin tetracaprate, diglycerin tetralaurate, diglycerin tetramyristate, diglycerin tetrapalmitate, diglycerin triacetate propionate, diglycerin triacetate butyrate, diglycerin triacetate valerate, diglycerin triacetate hexanoate, diglycerin triacetate heptanoate, diglycerin triacetate caprylate, diglycerin triacetate pelargonate, diglycerin triacetate caprate, diglycerin triacetate laurate, diglycerin triacetate myristate, diglycerin triacetate palmitate, diglycerin triacetate stearate, diglycerin triacetate oleate, diglycerin diacetate dipropionate, diglycerin diacetate dibutyrate, diglycerin diacetate divalerate, diglycerin diacetate dihexanoate, diglycerin diacetate dipentanoate, diglycerin diacetate dicaprylate, diglycerin diacetate dipelargonate, diglycerin diacetate dicaprate, diglycerin diacetate dilaurate, diglycerin diacetate dimyristate, diglycerin diacetate dipalmitate, diglycerin diacetate distearate, diglycerin diacetate dioleate, diglycerin acetate tripropionate, diglycerin acetate tributyrate, diglycerin acetate trivalerate, diglycerin acetate trihexanoate, diglycerin acetate triheptanoate, diglycerin acetate tricaprylate, diglycerin acetate tripelargonate, diglycerin acetate tricaprate, diglycerin acetate trilaurate, diglycerin acetate trimyristate, diglycerin acetate tripalmitate, diglycerin acetate tristearate, diglycerin acetate trioleate, diglycerin laurate, diglycerin stearate, diglycerin caprylate, diglycerin myristate, diglycerin oleate, to which, however, the invention should not be limited. One or more of these may be used herein either singly or as combined.

Of the above, preferred are diglycerin tetraacetate, diglycerin tetrapropionate, diglycerin tetrabutyrate, diglycerin tetracaprylate, diglycerin tetralaurate.

Examples of the polyalkylene glycols are polyethylene glycol and polypropylene glycol having a mean molecular weight of from 200 to 1000, to which, however, the invention should not be limited. One or more of these may be used herein either singly or as combined.

Examples of the compounds of polyalkylene glycols with an acyl group bonding to the hydroxyl group thereof are polyoxyethylene acetate, polyoxyethylene propionate, polyoxyethylene butyrate, polyoxyethylene valerate, polyoxyethylene caproate, polyoxyethylene heptanoate, polyoxyethylene octanoate, polyoxyethylene nonanoate, polyoxyethylene caprate, polyoxyethylene laurate, polyoxyethylene myristate, polyoxyethylene palmitate, polyoxyethylene stearate, polyoxyethylene oleate, polyoxyethylene linolate, polyoxypropylene acetate, polyoxypropylene propionate, polyoxypropylene butyrate, polyoxypropylene valerate, polyoxypropylene caproate, polyoxypropylene heptanoate, polyoxypropylene octanoate, polyoxypropylene nonanoate, polyoxypropylene caprate, polyoxypropylene laurate, polyoxypropylene myristate, polyoxypropylene palmitate, polyoxypropylene stearate, polyoxypropylene oleate, polyoxypropylene linolate, to which, however, the invention should not be limited. One or more of these may be used herein either singly or as combined.

The amount of the plasticizer to be added to the cellulose acylate film is preferably from 0 to 20% by mass of the film, more preferably from 1 to 20% by mass, even more preferably from 2 to 15% by mass. If desired, two or more suchplasticizers may be used as combined.

Apart from the plasticizer, other various additives (e.g., UV inhibitor, thermal degradation inhibitor, coloration inhibitor, optical anisotropy controller, fine particles, IR absorbent, surfactant, odor trapper, (e.g., amine)) may be added to the polymer of the invention.

IR absorbent dyes as in JP-A-2001-194522 are usable herein; and UV absorbents as in JP-A-2001-151901 are usable herein. Preferably, the amount of the absorbent to be added to cellulose acylate is from 0.001 to 5% by mass of the polymer.

For stabilizers for thermal degradation inhibition or coloration inhibition, herein usable are epoxy compounds, weak organic acids, phosphates, thiophosphate compounds, phosphites (e.g., as in JP-A-51-70316, JP-A-10-306175, JP-A-57-78431, JP-A-54-157159, JP-A-55-13765), phosphite compounds (as in JP-A-2004-182979). One or more of these may be used here in either singly or as combined.

Preferably, the fine particles for use herein have a mean particle size of from 5 to 3000 nm, and they may be formed of a metal oxide or a crosslinked polymer. Their amount to be in cellulose acylate is preferably from 0.001 to 5% by mass of the polymer. The amount of the antioxidant is preferably from 0.0001 to 2% by mass of cellulose acylate. For the optical anisotropy controller, for example, herein usable are those described in JP-A-2003-66230 and JP-A-2002-49128. Preferably, the amount of the optical anisotropy controller is from 0.1 to 15% by mass of cellulose acylate.

### (Melt Film Formation)

### (1) Drying:

The pellets prepared in the manner as above are preferably used. Prior to melt film formation, the pellets are preferably dried to have a water content of at most 1%, more preferably at most 0.5%, and they are put into the hopper of a melt extruder. In this stage, the hopper is kept preferably at a temperature falling between (Tg−50° C.) and (Tg+30° C.), more preferably between (Tg−40° C.) and (Tg+10° C.), even more preferably between (Tg−30° C.) and Tg. In that condition, water is prevented from being re-adsorbed by the polymer in the hopper and the drying efficiency may be therefore higher.

### (2) Kneading Extrusion:

Cellulose acylate is melt-kneaded preferably at 120° C. to 250° C., more preferably at 140° C. to 220° C. In this stage, the melting temperature may be kept constant all the time, or may be varied to have a controlled temperature profile that varies in some sections. Preferably, the time for the kneading operation is from 2 minutes to 60 minutes, more preferably from 3 minutes to 40 minutes, even more preferably from 4 minutes to 30 minutes. Further, it is also desirable that the inner atmosphere of the melt extruder is an inert gas (e.g., nitrogen) atmosphere, or a vented extruder is used while it is degassed into vacuum via its vent.

### (3) Casting:

The resin melt is introduced into a gear pump, the pulsation of the extruder is removed, and the melt is filtered through a metal mesh filter or the like, and then extruded out through the T-die fitted after the filter onto a cooling drum to form a sheet thereon. The extrusion may be for single-layer film formation, or may be multi-layer film formation via a multi-manifold die or a feed block. In this stage, the die lip distance may be controlled to thereby control the thickness unevenness in the transverse direction of the film.

Then the resin melt is extruded out onto a casting drum. In this stage, preferably employed is an electrostatic charging method, an air knife method, an air chamber method, a vacuum nozzle method or a touch roll method, in which the adhesiveness between the casting drum and the melt-extruded sheet is increased. The adhesion improving method may be employed entirely or partly in the melt-extruded sheet.

Preferably, the temperature of the casting drum is from 60° C. to 160° C., more preferably from 70° C. to 150° C., even more preferably from 80° C. to 150° C. After the step, the film is peeled off from the casting drum, then led to nip rolls and wound up. The winding speed is preferably from 10 m/min to 100 m/min, more preferably from 15 m/min to 80 m/min, even more preferably from 20 m/min to 70 m/min.

The width of the film formed is preferably from 1 m to 5 m, more preferably from 1.2 m to 4 m, even more preferably from 1.3 m to 3 m. Thus obtained, the thickness of the unstretched film is preferably from 30 μm to 400 μm, more preferably from 40 μm to 300 μm, even more preferably from 50 μm to 200 μm.

Preferably, the thus-obtained film is trimmed at both edges thereof and then wound up. The trimmed scraps may be ground, then optionally granulated, depolymerized/repolymerized, and recycled as the starting material for the same type or a different type of films. Before wound up, it is also desirable that the film is laminated with an additional film on at least one surface thereof for preventing it from being scratched and damaged.

### (Stretching)

Preferably, the film is stretched at a temperature falling between Tg and (Tg+50° C.), more preferably between (Tg+1° C.) and (Tg+30° C.), even more preferably between (Tg+2° C.) and (Tg+20° C.). Also preferably, the draw ratio for the stretching is from 10 to 300%, more preferably from 20 to 250%, even more preferably from 30 to 200%. The stretching may be effected in one stage or in multiple stages. The draw ratio may be obtained according to the following formula:

Draw Ratio(%)=100×{(length after stretching)−(length before stretching)}/(length before stretching).

The stretching may be effected in a mode of machine-direction stretching or transverse-direction stretching or their combination. The machine-direction stretching includes roll stretching (using at least two pairs of nip rolls of which the speed of the roll on the take-out side is kept higher, the film is stretched in the machine direction), edge fixed stretching (both edges of the film are fixed, and the film is stretched by conveying it in the machine direction gradually at an elevated speed in the machine direction). The transverse-direction stretching may be tenter stretching (both edges of the film are held with a chuck, and the film is expanded and stretched in the transverse direction (in the direction perpendicular to the machine direction)). The machine-direction stretching and the transverse-direction stretching may be effected either alone (monoaxial stretching) or may be combined (biaxial stretching. In the biaxial stretching, the machine-direction stretching and the transverse-direction stretching may be effected successively (successive stretching) or simultaneously (simultaneous stretching).

Both in the machine-direction stretching and the transverse-direction stretching, the stretching speed is preferably from 10%/min to 10000%/min, more preferably from 20%/min to 1000%/min, even more preferably from 30%/min to 800%/min. In the multi-stage stretching, the stretching speed is the mean value of the stretching speed in each stage.

After thus stretched inthemanner as above, it is desirable that the film is relaxed in the machine direction or in the transverse direction by from 0% to 10%. Further, after thus stretched, it is also desirable that the film is thermally fixed at 150° C. to 250° C. for 1 second to 3 minutes.

Rth of the thus-stretched film preferably falls within the above-mentioned range, and Re thereof is preferably from 20 nm to 300 nm, more preferably from 30 nm to 250 nm, even more preferably from 40 nm to 200 nm.

Re as referred to herein is defined by the following formula:

Re=|n_{md}−n_{td}|×d

wherein n_{md} and n_{td} each indicate the refractive index of the film in the machine direction (md) and in the transverse direction (TD); and d indicates the thickness of the film (as a unit of nm).

Re and Rth of the film are preferably Re≦Rth, more preferably Re×1.5≦Rth, even more preferably Re≦Rth×2. The film having such Re and Rth can be obtained by edge-fixed monoaxial stretching, more preferably by biaxial stretching in both the machine direction and the transverse direction. This is because, when the film is stretched in both the machine direction and the transverse direction, then the difference between the in-plane refractivity (n_{md}, n_{td}) may be reduced and Re may be thereby reduced, and further, since the film is stretched in both the machine direction and the transverse direction to thereby enlarge the area thereof, the alignment in the thickness direction may be enhanced with the reduction in the thickness of the thus-stretched film, therefore resulting in the increase in Rth. Having such Re and Rth, the film is effective for further reducing the light leakage at the time of black level of display.

After thus stretched, the thickness of the film is preferably from 10 to 300 μm, more preferably from 20 μm to 200 μm, even more preferably from 30 μm to 100 μm.

Preferably, the angle θ formed by the film-traveling direction (machine direction) and the slow axis of Re of the film is nearer to 0°, +90° or −90°. Concretely, in machine-direction stretching, the angle is preferably nearer to 0°, more preferably to 0±3°, even more preferably to 0±2°, still more preferably to 0±1°. In cross-direction stretching, the angle is preferably 90±3° or −90±3°, more preferably 90±2° or −90±2°, even more preferably 90±1° or −90±1°.

The unstretched or stretched cellulose acylate film may be used either alone or as combined with a polarizer; and a liquid-crystal layer or a layer having a controlled refractivity (low-refractivity layer) or a hard coat layer may be provided on it for use herein.

### (Surface Treatment)

The cellulose acylate film may be optionally subjected to surface treatment to thereby improve the adhesiveness between the cellulose acylate film and various functional layers (e.g., undercoat layer, back layer) adjacent thereto. The surface treatment is, for example, glow discharge treatment, UV irradiation treatment, corona treatment, flame treatment, or acid or alkali treatment. The glow discharge treatment as referred to herein is preferably low-temperature plasma treatment to be effected under a low gas pressure of from 10⁻³ to 20 Torr, or plasma treatment under atmospheric pressure. The plasma-exciting vapor to be used in the plasma treatment is a vapor that is excited by plasma under the condition as above. The plasma-exciting vapor includes, for example, argon, helium, neon, krypton, xenon, nitrogen, carbon dioxide, flons such as tetrafluoromethane, and their mixtures. Their details are described in Hatsumei Kyokai Disclosure Bulletin (No. 2001-1745, published by the Hatsumei Kyokai on Mar. 15, 2001), pp. 30-32. For the plasma treatment under atmospheric pressure that has become specifically noted recently, preferably used is irradiation energy of from 20 to 500 kgy under 10 to 1000 Kev, more preferably from 20 to 300 kgy under 30 to 500 Kev. Of the above-mentioned treatments, more preferred is alkali saponification, and this is extremely effective for the surface treatment of cellulose acylate films.

For the alkali saponification, the film to be processed may be dipped in a saponification solution or may be coated with it. In the dipping method, the film may be led to pass through a tank of an aqueous NaOH or KOH solution having a pH of from 10 to 14 at 20 to 80° C., taking 0.1 minutes to 10 minutes, and then neutralized, washed with water and dried.

When the alkali saponification is attained according to a coating method, employable for it are a dip-coating method, a curtain-coating method, an extrusion-coating method, a bar-coating method and an E-type coating method. The solvent for the alkali saponification coating solution is preferably so selected that the saponification solution comprising it may well wet a transparent support to which the solution is applied, and that the solvent does not roughen the surface of the transparent support and may keep the support having a good surface condition. Concretely, alcohol solvents are preferred, and isopropyl alcohol is more preferred. An aqueous solution of surfactant may also be used as the solvent. The alkali to be in the alkali saponification coating solution is preferably an alkali soluble in the above-mentioned solvent. More preferably, it is KOH or NaOH. The pH of the saponification coating solution is preferably at least 10, more preferably at least 12. The alkali saponification time is preferably from 1 second to 5 minutes at room temperature, more preferably from 5 seconds to 5 minutes, even more preferably from 20 seconds to 3 minutes. After the alkali saponification treatment, it is desirable that the saponification solution-coated surface of the film is washed with water or with an acid and then further washed with water. If desired, the coating saponification treatment may be effected continuously with the alignment film removal treatment that will be mentioned hereinunder. In that manner, the number of the processing steps in producing the film may be decreased. Concretely, for example, the saponification method is described in JP-A-2002-82226 and WO02/46809, and this may be employed herein.

Preferably, the film of the invention is provided with an undercoat layer for improving the adhesiveness thereof to the functional layers to be formed thereon. The undercoat layer may be formed on the film after the above-mentioned surface treatment, or may be directly formed thereon with no surface treatment. The details of the undercoat layer are described in Hatsumei Kyokai Disclosure Bulletin (No. 2001-1745, published on Mar. 15, 2001 by the Hatsumei Kyokai), p. 32.

The step of surface treatment and undercoat layer formation may be carried out singly or as combined with the last step in the process of film formation. Further, the step may also be carried out along with the step of forming the functional groups to be mentioned hereinunder.

### (Functional Layers)

Preferably, the cellulose acylate film of the invention is combined with functional layers described in detail in Hatsumei Kyokai Disclosure Bulletin (No. 2001-1745, published on Mar. 15, 2001 by the Hatsumei Kyokai), pp. 32-45. Above all, it is desirable that the film is provided with a polarizing layer (for polarizer), an optically-compensatory layer (for optically-compensatory sheet) and an antireflection layer (for antireflection film).

### (1) Formation of Polarizing Layer (Construction of Polarizer)

### [Materials]

At present, one general method of producing commercially-available polarizing films comprises dipping a stretched polymer in a solution containing iodine or dichroic dye in a bath to thereby infiltrate iodine or dichroic dye into the binder. As the polarizing film, a coated polarizing film such as typically that by Optiva Inc. may be utilized. Iodine and dichroic dye in the polarizing film are aligned in the binder and express the polarization property. The dichroic dye includes azo dyes, stilbene dyes, pyrazolone dyes, triphenylmethane dyes, quinoline dyes, oxazine dyes, thiazine dyes and anthraquinone dyes. Preferably, the dichroic dye is soluble in water. Also preferably, the dichroic dye has a hydrophilic substituent (e.g., sulfo, amino, hydroxyl). For example, the compounds described in Hatsumei Kyokai Disclosure Bulletin (No. 2001-1745, published on Mar. 15, 2001 by the Hatsumei Kyokai), p. 58 may be used as the dichroic dye herein.

For the binder for the polarizing film, usable are a polymer that is crosslinkable by itself, and a polymer that is crosslinkable with a crosslinking agent. These polymers may be combined for use herein. The binder includes, for example, methacrylate copolymers, styrene copolymers, polyolefins, polyvinyl alcohols, modified polyvinyl alcohols, poly(N-methylolacrylamides), polyesters, polyimides, vinyl acetate copolymers, carboxymethyl cellulose and polycarbonates, as in JP-A-8-338913, [0022]. In addition, a silane coupling agent may also be used as the polymer. Above all, water-soluble polymers (e.g., poly(N-methylolacrylamide), carboxymethyl cellulose, gelatin, polyvinyl alcohol, modified polyvinyl alcohol) are preferred; gelatin, polyvinyl alcohol and modified polyvinyl alcohol are more preferred; and polyvinyl alcohol and modified polyvinyl alcohol are most preferred. Especially preferably, two different types of polyvinyl alcohols or modified polyvinyl alcohols having a different degree of polymerization are combined for use herein. Preferably, the degree of saponification of polyvinyl alcohol for use herein is from 70 to 100%, more preferably from 80 to 100%. Also preferably, the degree of polymerization of polyvinyl alcohol is from 100 to 5000. Modified polyvinyl alcohols are described in JP-A-8-338913, JP-A-9-152509 and JP-A-9-316127. Two or more different types of polyvinyl alcohols and modified polyvinyl alcohols may be combined for use herein.

Preferably, the lowermost limit of the thickness of the binder is 10 μm. Regarding the uppermost limit of the thickness thereof, it is preferably thinner from the viewpoint of the light leakage resistance thereof in liquid-crystal display devices. Concretely, for example, it is desirable that the thickness of the polarizing film is not larger than the same level as that of currently commercially-available polarizers (about 30 μm), more preferably it is at most 25 μm, even more preferably at most 20 μm.

The binder of the polarizing film may be crosslinked. A polymer or a monomer having a crosslinking functional group may be incorporated into the binder, or the binder polymer may be so designed that it has a crosslinking functional group by itself. The crosslinking may be attained through exposure to light or heat or through pH change, and it gives a binder having a crosslinked structure therein. The crosslinking agent is described in US Reissue Pat. No. 23,297. A boron compound (e.g., boric acid, borax) may also be used as a crosslinking agent. The amount of the crosslinking agent to be added to the binder is preferably from 0.1 to 20% by mass of the binder. Within the range, the alignment of the polarizer element and the wet heat resistance of the polarizing film are both good.

After the crosslinking reaction, it is desirable that the amount of the unreacted crosslinking agent still remaining in the polarizing film is at most 1.0% by mass, more preferably at most 0.5% by mass. Within the range, the polarizing film may have good weather resistance.

### [Stretching]

Preferably, the polarizing film is stretched (according to a stretching process) or rubbed (according to a rubbing process), and then dyed with iodine or dichroic dye.

In the stretching process, the draw ratio is preferably from 2.5 to 30.0 times, more preferably from 3.0 to 10.0 times. The stretching may be attained in dry in air. Contrary to this, the stretching may also be attained in wet while the film is dipped in water. Preferably, the draw ratio in dry stretching is from 2.5 to 5.0 times, and the draw ratio in wet stretching is from 3.0 to 10.0 times. The stretching may be attained in parallel to the MD direction (parallel stretching) or in the direction oblique to the MD direction (oblique stretching). The stretching may be effected once, or a few times. When the stretching is effected a few times, then the film may be more uniformly stretched even at a high draw ratio.

Preferably, the film is stretched obliquely in the direction inclined by from 10 to 80 degrees relative to the MD direction.

### (a) Parallel Stretching Method:

Before stretched, PVA film is swollen. The degree of swelling of the film is from 1.2 to 2.0 times (in terms of the ratio by mass of the swollen film to the unswollen film). Next, the film is continuously conveyed via guide rolls, and led into a bath of an aqueous medium or into a dyeing bath of a dichroic substance solution. In the bath, in general, the film is stretched at a bath temperature of from 15 to 50° C., preferably from 17 to 40° C. The stretching may be effected by holding the film with two pairs of nip rolls, and the conveying speed of the latter-stage nip rolls is kept higher than that of the former-stage nip rolls. In view of the above-mentioned effects and advantages, the draw ratio in stretching (ratio of the length of stretched film/length of initial film—the same shall apply hereinunder) is preferably from 1.2 to 3.5 times, more preferably from 1.5 to 3.0 times. Next, the stretched film is dried at 50 to 90° C. to be a polarizing film.

### (b) Oblique Stretching Method:

For the oblique stretching method employable herein, referred to is the method described in JP-A-2002-86554. The method comprises using a tenter tensed in the direction oblique to the machine direction, and stretching a film with it. The stretching is effected in air, and therefore the film to be stretched must be previously watered so as to facilitate its stretching. Preferably, the water content of the watered film is from 5 to 100%, more preferably from 10 to 100%.

Preferably, the temperature in stretching is from 40 to 90° C., more preferably from 50 to 80° C. Also preferably, the humidity in stretching is from 50 to 100% RH, more preferably from 70 to 100% RH, even more preferably from 80 to 100% RH. The film traveling speed in the machine direction in stretching is preferably at least 1 m/min, more preferably at least 3 m/min.

After thus stretched, the film is then dried preferably at 50 to 100° C., more preferably at 60 to 90° C., preferably for 0.5 to 10 minutes, more preferably for 1 to 5 minutes.

Preferably, the absorption axis of the polarizing film thus obtained is from 10 to 80 degrees, more preferably from 30 to 60 degrees, even more preferably substantially 45 degrees (40 to 50 degrees).

### [Lamination]

The saponified cellulose acylate film is laminated with a polarizing film prepared by stretching to thereby construct a polarizer. The direction in which the two are laminated is preferably so controlled that the casting axis direction of the cellulose acylate film crosses the stretching axis direction of the polarizer at an angle of 45 degrees.

Not specifically defined, the adhesive for the lamination may be an aqueous solution of a PVA resin (including modified PVA with any of acetoacetyl group, sulfonic acid group, carboxyl group and oxyalkylene group) or a boron compound. Above all, preferred are PVA resins. The thickness of the adhesive layer is preferably from 0.01 to 10 μm, more preferably from 0.05 to 5 μm, after dried.

The light transmittance of the thus-obtained polarizer is preferably higher, and the degree of polarization thereof is also preferably higher. Concretely, the transmittance of the polarizer preferably falls between 30 and 50% for the light having a wavelength of 550 nm, more preferably between 35 and 50%, even more preferably between 40 and 50%. The degree of polarization of the polarizer preferably falls between 90 and 100% forthe lighthavingawavelengthof 550 nm, morepreferably between 95 and 100%, even more preferably between 99 and 100%.

Further, the thus-constructed polarizer may be laminated with a λ/4plate to form a circularly-polarizing plate. In this case, the two are so laminated that the slow axis of the λ/4 plate meets the absorption axis of the polarizer at an angle of 45 degrees. In this, the λ/4 plate is not specifically defined but preferably has a wavelength dependency of such that its retardation is smaller at a lower wavelength. Further, it is also desirable to use a λ/4 plate that comprises a polarizing film of which the absorption axis is inclined by 20 to 70° relative to the machine direction and an optically-anisotropic layer of a liquid-crystalline compound.

### (2) Formation of Optical Compensatory Layer (Construction of Optical Compensatory Sheet):

An optically-compensatory layer is for compensating the liquid-crystalline compound in a liquid-crystal cell at the time of black level of display in liquid-crystal display devices, and this may be constructed by forming an alignment film on a cellulose acylate film followed by further forming thereon an optically-anisotropic layer.

### [Alignment Film]

An alignment film is provided on the cellulose acylate film that has been processed for surface treatment as above. The film has the function of defining the alignment direction of liquid-crystal molecules. However, if a liquid-crystalline compound can be aligned and then its alignment state can be fixed as such, then the alignment film is not indispensable as a constitutive element, and may be therefore omitted as not always needed. In this case, only the optically-anisotropic layer on the alignment film of which the alignment state has been fixed may be transferred onto a polarizing element to construct the polarizer of the invention.

The alignment film may be formed, for example, through rubbing treatment of an organic compound (preferably polymer), oblique vapor deposition of an inorganic compound, formation of a microgrooved layer, or accumulation of an organic compound (e.g., ω-tricosanoic acid, dioctadecylmethylammonium chloride, methyl stearate) according to a Langmuir-Blodgett's method (LB film). Further, there are known other alignment films that may have an alignment function through impartation of an electric field or magnetic field thereto or through light irradiation thereto.

The alignment film is preferably formed through rubbing treatment of a polymer. In principle, the polymer to be used for the alignment film has a molecular structure that has the function of aligning liquid-crystalline molecules.

Preferably, the polymer for use in the invention has a crosslinking functional group (e.g., double bond)—having side branches bonded to the backbone chain thereof or has a crosslinking functional group having the function of aligning liquid-crystalline molecules introduced into the side branches thereof, in addition to having the function of aligning liquid-crystalline molecules.

The polymer to be used for the alignment film may be a polymer that is crosslinkable by itself or a polymer that is crosslinkable with a crosslinking agent, or may also be a combination of the two. Examples of the polymer are methacrylate copolymers, styrene copolymers, polyolefins, polyvinyl alcohols and modified polyvinyl alcohols, poly(N-methylolacrylamides), polyesters, polyimides, vinyl acetate copolymers, carboxymethyl cellulose and polycarbonates, as in JP-A-8-338913, [0022]. A silane coupling agent is also usable as the polymer. Preferably, the polymer is a water-soluble polymer (e.g., poly(N-methylolacrylamide), carboxymethyl cellulose, gelatin, polyvinyl alcohol, modified polyvinyl alcohol), more preferably gelatin, polyvinyl alcohol and modified polyvinyl alcohol, even more preferably polyvinyl alcohol and modified polyvinyl alcohol. Especially preferably, two different types of polyvinyl alcohols or modified polyvinyl alcohols having a different degree of polymerization are combined for use as the polymer. Preferably, the degree of saponification of polyvinyl alcohol for use herein is from 70 to 100%, more preferably from 80 to 100%. Also preferably, the degree of polymerization of polyvinyl alcohol is from 100 to 5000.

The side branches having the function of aligning liquid-crystalline molecules generally have a hydrophobic group as the functional group. Concretely, the type of the functional group may be determined depending on the type of the liquid-crystalline molecules to be aligned and on the necessary alignment state of the molecules.

For example, the modifying group of modified polyvinyl alcohol may be introduced into the polymer through copolymerization modification, chain transfer modification or block polymerization modification. Examples of the modifying group are a hydrophilic group (e.g., carboxylic acid group, sulfonic acid group, phosphonic acid group, amino group, ammonium group, amido group, thiol group), a hydrocarbon group having from 10 to 100 carbon atoms, a fluorine atom-substituted hydrocarbon group, a thioether group, a polymerizing group (e.g., unsaturated polymerizing group, epoxy group, aziridinyl group), and an alkoxysilyl group (e.g., trialkoxy group, dialkoxy group, monoalkoxy group). Specific examples of such modified polyvinyl alcohol compounds are described, for example, in JP-A-2000-155216, [0022] to [0145], and in JP-A-2002-62426, [0018] to [0022].

When crosslinking functional group-having side branches are bonded to the backbone chain of an alignment film polymer, or when a crosslinking functional group is introduced into the side chains of a polymer having the function of aligning liquid-crystalline molecules, then the polymer of the alignment film may be copolymerized with the polyfunctional monomer in an optically-anisotropic layer. As a result, not only between the polyfunctional monomers but also between the alignment film polymers, and even between the polyfunctional monomer and the alignment film polymer, they may be firmly bonded to each other in a mode of covalent bonding to each other. Accordingly, introducing such a crosslinking functional group into an alignment film polymer significantly improves the mechanical strength of the resulting optical compensatory sheet.

Preferably, the crosslinking functional group of the alignment film polymer contains a polymerizing group, like the polyfunctional monomer. Concretely, for example, those described in JP-A-2000-155216, [0080] to [0100] are referred to herein. Apart from the above-mentioned crosslinking functional group, the alignment film polymer may also be crosslinked with a crosslinking agent.

The crosslinking agent includes, for example, aldehydes, N-methylol compounds, dioxane derivatives, compounds capable of being active through activation of the carboxyl group thereof, active vinyl compounds, active halide compound, isoxazoles and dialdehyde starches. Two or more different types of crosslinking agents may be combined for use herein. Concretely, for example, the compounds described in JP-A-2002-62426, [0023] to [0024] are employable herein. Preferred are aldehydes of high reactivity, and more preferred is glutaraldehyde.

Preferably, the amount of the crosslinking agent to be added to polymer is from 0.1 to 20% by mass of the polymer, more preferably from 0.5 to 15% by mass. Also preferably, the amount of the unreacted crosslinking agent that may remain in the alignment film is at most 1.0% by mass, more preferably at most 0.5% by mass. When the crosslinking agent in the alignment film is controlled to that effect, then the film ensures good durability with no reticulation even though it is used in liquid-crystal display devices for a long period of time and even though it is left in a high-temperature high-humidity atmosphere for a long period of time.

Basically, the alignment film may be formed by applying the alignment film-forming material of the above-mentioned polymer to a crosslinking agent-containing transparent support, then heating and drying it (for crosslinking it) and then rubbing the thus-formed film. The crosslinking reaction may be effected in any stage after the film-forming material has been applied onto the transparent support, as so mentioned hereinabove. When a water-soluble polymer such as polyvinyl alcohol is used as the alignment film-forming material, then it is desirable that the solvent for the coating solution is a mixed solvent of a defoaming organic solvent (e.g., methanol) and water. The ratio by mass of water/methanol preferably falls between 0/100 and 99/1, more preferably between 0/100 and 91/9. The mixed solvent of the type is effective for preventing the formation of bubbles in the coating solution and, as a result, the surface defects of the alignment film and even the optically-anisotropic layer are greatly reduced.

For forming the alignment film, preferably employed is a spin-coating method, a dip-coating method, a curtain-coating method, an extrusion-coating method, a rod-coating method or a roll-coating method. Especially preferred is a rod-coating method. Also preferably, the thickness of the film is from 0.1 to 10 μm, after dried. The drying under heat may be effected at 20 to 110° C. For sufficient crosslinking, the heating temperature is preferably from 60 to 100° C., more preferably from 80 to 100° C. The drying time may be from 1 minute to 36 hours, but preferably from 1 to 30 minutes. The pH of the coating solution is preferably so defined that it is the best for the crosslinking agent used. For example, when glutaraldehyde is used, the pH of the coating solution is preferably from 4.5 to 5.5, more preferably 5.

The alignment film is provided on the transparent support or on the undercoat layer. The alignment film may be formed by crosslinking the polymer layer as above, and then rubbing the surface of the layer.

For the rubbing treatment, usable is any method widely employed for liquid crystal alignment treatment in producing liquid-crystal display devices. Concretely, for example, the surface of the alignment film is rubbed in a predetermined direction by the use of paper, gauze, felt, rubber, nylon, or polyester fibers, whereby the film may be aligned in the intended direction. In general, a cloth uniformly planted with fibers having the same length and the same thickness is used, and the surface of the film is rubbed a few times with the cloth.

On an industrial scale, the operation may be attained by contacting a rolling rubbing roll to a polarizing layer-having film that is traveling in the system. Preferably, the circularity, the cylindricity, and the deflection (eccentricity) of the rubbing roll are all at most 30 μm each. Also preferably, the lapping angle of the film around the rubbing roll is from 0.1 to 90°. However, the film may be lapped at an angle of 360° or more for stable rubbing treatment, as in JP-A-8-160430. Preferably, the film traveling speed is from 1 to 100 m/min. The rubbing angle may fall between 0 and 60°, and it is desirable that a suitable rubbing angle is selected within the range. When the film is used in liquid-crystal display devices, the rubbing angle is preferably from 40 to 50°, more preferably 45°.

The thickness of the alignment film thus obtained is preferably from 0.1 to 10 μm.

The liquid-crystalline molecules for use in the optically-anisotropic layer include rod-shaped liquid-crystalline molecules and discotic liquid-crystalline molecules. The rod-shaped liquid-crystalline molecules and the discotic liquid-crystalline molecules may be high-molecular liquid crystals or low-molecular liquid crystals. In addition, they include crosslinked low-molecular liquid crystals that do not exhibit liquid crystallinity.

### [Rod-Shaped Liquid-Crystalline Molecules]

The rod-shaped liquid-crystalline molecules are preferably azomethines, azoxy compounds, cyanobiphenyls, cyanophenyl esters, benzoates, phenyl cyclohexanecarboxylates, cyanophenylcyclohexanes, cyano-substituted phenylpyrimidines, alkoxy-substituted phenylpyrimidines, phenyldioxanes, phenylditolanes and alkenylcyclohexylbenzonitriles.

The rod-shaped liquid-crystalline molecules include metal complexes. Liquid-crystal polymers that contain rod-shaped liquid-crystalline molecules in the repetitive units thereof are also usable herein as the rod-shaped liquid-crystalline molecules. In other words, the rod-shaped liquid-crystalline molecules for use herein may bond to a (liquid-crystal) polymer.

Rod-shaped liquid-crystalline molecules are described in Quarterly Journal of General Chemistry, Vol. 22, Liquid Crystal Chemistry (1994), Chaps. 4, 7 and 11, edited by the Chemical Society of Japan; Liquid Crystal Devices Handbook, edited by the 142nd Committee of the Nippon Academic Promotion, Chap. 3.

The birefringence of the rod-shaped liquid-crystalline molecule preferably falls between 0.001 and 0.7.

Preferably, the rod-shaped liquid-crystalline molecules have a polymerizing group for fixing their alignment state. The polymerizing group is preferably a radical-polymerizing unsaturated group or a cationic polymerizing group. Concretely, for example, there are mentioned the polymerizing groups and the polymerizing liquid-crystal compounds described in JP-A-2002-62427, [0064] to [0086].

### [Discotic Liquid-Crystalline Molecules]

The discotic liquid-crystalline molecules include, for example, benzene derivatives as in C. Destrade et al's study report, Mol. Cryst., Vol. 71, p. 111 (1981); truxene derivatives as in C. Destrade et al's study report, Mol. Cryst., Vol. 122, p. 141 (1985), Physics Lett. A., Vol. 78, p. 82 (1990); cyclohexane derivatives as in B. Kohne et al's study report, Angew. Chem., Vol. 96, p. 70 (1984); and azacrown-type or phenylacetylene-type macrocycles as in J. M. Lehn et al's study report, J. Chem. Commun., p. 1794 (1985), J. Zhang et al's study report, J. Am. Chem. Soc., Vol. 116, p. 2655 (1994).

The discotic liquid-crystalline molecules include liquid-crystalline compounds in which the molecular center nucleus is radially substituted with side branches of a linear alkyl, alkoxy or substituted benzoyloxy group. Preferably, the molecules or the molecular aggregates of the compounds are rotary-symmetrical and may undergo certain alignment. It is not always necessary that, in the optically-anisotropic layer formed of such discotic liquid-crystalline molecules, the compounds that are finally in the optically-anisotropic layer are discotic liquid-crystalline molecules. For example, low-molecular discotic liquid-crystalline molecules may have a group capable of being reactive when exposed to heat or light, and as a result, they may polymerize or crosslink through thermal or optical reaction to give high-molecular compounds with no liquid crystallinity. Preferred examples of the discotic liquid-crystalline molecules are described in JP-A-8-50206. Polymerization of discotic liquid-crystalline molecules is described in JP-A-8-27284.

For fixing the discotic liquid-crystalline molecules through polymerization, the discotic core of the discotic liquid-crystalline molecules must be substituted with a polymerizing group. Preferably, the polymerizing group bonds to the discotic core via a linking group. Accordingly, the compounds of the type may keep their alignment state even after their polymerization. For example, there are mentioned the compounds described in JP-A-2000-155216, [0151] to [0168].

In hybrid alignment, the angle between the major axis (disc plane) of the discotic liquid-crystalline molecules and the plane of the polarizing film increases or decreases with the increase in the distance from the plane of the polarizing film in the depth direction of the optically-anisotropic layer. Preferably, the angle decreases with the increase in the distance. The angle change may be in any mode of continuous increase, continuous decrease, intermittent increase, intermittent decrease, change including continuous increase and continuous decrease, or intermittent change including increase and decrease. The intermittent change includes a region in which the tilt angle does not change in the midway of the thickness direction. The angle may include a region with no angle change so far as it increases or decreases as a whole. Preferably, the angle continuously varies.

The mean direction of the major axis of the discotic liquid-crystalline molecules on the polarizing film side may be controlled generally by suitably selecting the material of the discotic liquid-crystalline molecules or that of the alignment film or by suitably selecting the rubbing treatment method. The direction of the major axis of the discotic liquid-crystalline molecules (disc plane) on the surface side (on the external air side) may be controlled generally by suitably selecting the material of the discotic liquid-crystalline molecules or that of the additive to be used along with the discotic liquid-crystalline molecules. Examples of the additive that may be used along with the discotic liquid-crystalline molecules include, for example, plasticizer, surfactant, polymerizing monomer and polymer. Like in the above, the degree of the change of the major axis in the alignment direction may also be controlled by suitably selecting the liquid-crystalline molecules and the additive.

### (Other Composition of Optically-Anisotropic Layer)

Along with the above-mentioned liquid-crystalline molecules, a plasticizer, a surfactant, a polymerizing monomer and others may be added to the optically-anisotropic layer for improving the uniformity of the coating film, the strength of the film and the alignment of the liquid-crystalline molecules in the film. Preferably, the additives have good compatibility with the liquid-crystalline molecules that constitute the layer and may have some influence on the tilt angle change of the liquid-crystalline molecules, not interfering with the alignment of the molecules.

The polymerizing monomer includes radical-polymerizing or cationic-polymerizing compounds. Preferred are polyfunctional radical-polymerizing monomers. Also preferred are those copolymerizable with the above-mentioned, polymerizing group-containing liquid-crystal compounds. For example, herein mentioned are the compounds described in JP-A-2002-296423, [0018] to [0020]. The amount of the compound to be added to the layer may be generally from 1 to 50% by mass of the discotic liquid-crystalline molecules in the layer, but preferably from 5 to 30% by mass.

The surfactant may be any known one, but is preferably a fluorine-containing compound. Concretely, for example, there are mentioned the compounds described in JP-A-2001-330725, [0028] to [0056].

The polymer that may be used along with the discotic liquid-crystalline molecules is preferably one capable of changing the tilt angle of the discotic liquid-crystalline molecules.

Examples of the polymer are cellulose esters. Preferred examples of cellulose esters are described in JP-A-2000-155216, [0178]. So as not to interfere with the alignment of the liquid-crystalline molecules in the layer, the amount of the polymer to be added to the layer is preferably from 0.1 to 10% by mass of the liquid-crystalline molecules, more preferably from 0.1 to 8% by mass.

Preferably, the discotic nematic liquid-crystal phase/solid phase transition temperature of the discotic liquid-crystalline molecules falls between 70 and 300° C., more preferably between 70 and 170° C.

### [Formation of Optically-Anisotropic Layer]

The optically-anisotropic layer may be formed by applying a coating solution that contains liquid-crystalline molecules and optionally a polymerization initiator and other optional components mentioned below, on the alignment film.

The solvent to be used in preparing the coating solution is preferably an organic solvent. Examples of the organic solvent are amides (e.g., N,N-dimethylformamide), sulfoxides (e.g., dimethylsulfoxide), heterocyclic compounds (e.g., pyridine), hydrocarbons (e.g., benzene, hexane), alkyl halides (e.g., chloroform, dichloromethane, tetrachloroethane), esters (e.g., methyl acetate, butyl acetate), ketones (e.g., acetone, methyl ethyl ketone), ethers (e.g., tetrahydrofuran, 1,2-dimethoxyethane). Of those, preferred are alkyl halides and ketones. Two or more such organic solvents may be used as combined.

The coating solution may be applied onto the alignment film in any known method (e.g., wire bar coating, extrusion coating, direct gravure coating, reverse gravure coating, die coating).

The thickness of the optically-anisotropic layer is preferably from 0.1 to 20 μm, more preferably from 0.5 to 15 μm, even more preferably from 1 to 10 μm.

### [Fixation of Alignment State of Liquid-Crystalline Molecules]

The aligned liquid-crystalline molecules may be fixed as they are in an alignment state. Preferably, the fixation is effected through polymerization. The polymerization includes thermal polymerization with a thermal polymerization initiator and optical polymerization with an optical polymerization initiator. Preferred is optical polymerization.

The optical polymerization initiator includes, for example, α-carbonyl compounds (as in U.S. Pat. Nos. 2,367,661, 2,367,670), acyloin ethers (as in U.S. Pat. No. 2,448,828), α-hydrocarbon-substituted aromatic acyloin compounds (as in U.S. Pat. No. 2,722,512), polynuclear quinone compounds (as in U.S. Pat. Nos. 3,046,127, 2,951,758), combination of triarylimidazole dimer and p-aminophenylketone (as in U.S. Pat. No. 3,549,367), acridine compounds and phenazine compounds (as in JP-A-60-105667, U.S. Pat. No. 4,239,850), and oxadiazole compounds (as in U.S. Pat. No. 4,212,970).

The amount of the optical polymerization initiator to be added is preferably from 0.01 to 20% by mass of the solid content of the coating solution, more preferably from 0.5 to 5% by mass.

Preferably, UV rays are used for light irradiation for polymerization of liquid-crystalline molecules.

Preferably, the irradiation energy falls within a range of from 20 mJ/cm² to 50 J/cm², more preferably from 20 to 5000 mJ/cm², even more preferably from 100 to 800 mJ/cm². For promoting the optical polymerization, the light irradiation may be effected under heat.

A protective layer may be provided on the optically-anisotropic layer.

Preferably, the optical compensatory film may be combined with a polarizing layer. Concretely, the above-mentioned optically-anisotropic layer-coating solution is applied onto the surface of a polarizing film to from an optically-anisotropic layer thereon. As a result, no polymer film exists between the polarizing film and the optically-anisotropic layer, and a thin polarizer is thus constructed of which the stress (strain×cross section×elasticity) to be caused by the dimensional change of the polarizing film is reduced. When the polarizer of the invention is fitted to large-size liquid-crystal display devices, then it does not produce a problem of light leakage and the devices can display high-quality images.

Preferably, the polarizing layer and the optically-compensatory layer are so stretched that the tilt angle between the two may correspond to the angle formed by the transmission axis of the two polarizers to be stuck to both sides of the liquid crystal cell to constitute LCD, and the machine direction or the transverse direction of the liquid crystal cells. In general, the tilt angle is 45°. Recently, however, some devices in which the tile angle is not always 45° have been developed for transmission-type, reflection-type or semi-transmission-type LCDs, and it is desirable that the stretching direction is varied in any desired manner depending on the plan of LCDs.

### [Liquid-Crystal Display Device]

Various liquid-crystal modes using the optical compensatory film are described below.

### (TN-Mode Liquid-Crystal Display Device)

A TN-mode is most popularly utilized in color TFT liquid-crystal display devices, and this is described in a large number of references. The alignment state in the liquid-crystal cell at the time of black level of TN-mode display is as follows: The rod-shaped liquid-crystalline molecules stand up in the center of the cell, and they lie down at around the substrate of the cell.

### (OCB-Mode Liquid-Crystal Display Device)

This is a bent-alignment mode liquid-crystal cell in which the rod-shaped liquid-crystalline molecules are aligned substantially in the opposite directions (symmetrically) between the upper part and the lower part of the liquid-crystal cell. The liquid-crystal display device that comprises such a bent-alignment mode liquid-crystal cell is disclosed in U.S. Pat. Nos. 4,583,825 and 5,410,422. In this, since the rod-shaped liquid-crystalline molecules are symmetrically aligned in the upper part and the lower part of the liquid-crystal cell, the bent-alignment mode liquid-crystal cell has a self-optically-compensatory function. Accordingly, the liquid-crystal mode of the type is referred to as an OCB (optically-compensatory bent) liquid-crystal mode.

Regarding the alignment state at the time of black level of display in the OCB-mode liquid-crystal cell, the rod-shaped liquid-crystalline molecules stand up in the center of the cell, and they lie down at around the substrate of the cell, like in the TN-mode liquid-crystal cell.

### (VA-Mode Liquid-Crystal Display Device)

This is characterized in that the rod-shaped liquid-crystalline molecules therein are substantially vertically aligned in the absence of voltage application thereto. The VA-mode liquid-crystal cell includes (1) a VA-mode liquid-crystal cell in the narrow sense of the word, in which the rod-shaped liquid-crystalline molecules are substantially vertically aligned in the absence of voltage application thereto but are substantially horizontally aligned in the presence of voltage application thereto (as in JP-A-2-176625), further including in addition to it, (2) a multi-domain VA-mode (MVA-mode) liquid crystal cell for viewing angle expansion (as in SID97, Digest of Tech. Papers (preprint), 28 (1997) 845), (3) an n-ASM-mode liquid-crystal cell in which the rod-shaped liquid-crystalline molecules are substantially vertically aligned in the absence of voltage application thereto but are subjected to twisted multi-domain alignment in the presence of voltage application thereto (as in the preprint in the Nippon Liquid Crystal Discussion Meeting, 58-59 (1998)), and (4) a SURVAIVAL-mode liquid-crystal cell (as announced in LCD International 98).

### (Other Liquid-Crystal Display Devices)

IPS-mode, ECB-mode and STN-mode liquid-crystal display devices may be optically compensated in the same consideration as above.

### (3) Formation of Antireflection Layer (for Antireflection Film)

In general, an antireflection film is constructed by forming a low-refractivity layer that functions as a stain-preventing layer, and at least one layer having a higher refractivity than the low-refractivity layer (high-refractivity layer or middle-refractivity layer) on a transparent substrate.

A multi-layer film is formed by laminating transparent thin films of inorganic compounds (e.g., metal oxides) having a different refractivity, for example, in a mode of chemical vapor deposition (CVD) or physical vapor deposition (PVD); or a film of colloidal metal oxide particles is formed according to a sol-gel process with a metal compound such as a metal oxide, and then this is post-treated (e.g., UV irradiation as in JP-A-9-157855, or plasma treatment as in JP-A-2002-327310) to give a thin film.

On the other hand, various types of antireflection films of high producibility are proposed, which are formed by laminating thin films of inorganic particles dispersed in a matrix.

The antireflection films produced according to the above-mentioned coating methods may be further processed so that the surface of the outermost layer thereof is roughened to have an antiglare property.

The cellulose acylate film of the invention may be applied to any type as above. Especially preferably, the film is applied to film construction in a layers-coating system (layers-coated films).

### [Layer Constitution of Layers-Coated Antireflection Film]

The antireflection film having a layer constitution of at least a middle-refractivity layer, a high-refractivity layer and a low-refractivity layer (outermost layer) formed in that order on a substrate is so planned that it satisfies the refractivity profile mentioned below.

Refractivity of high-refractivity layer>refractivity of middle-refractivity layer>refractivity of low-refractivity layer.

A hard coat layer may be disposed between the transparent support and the middle-refractivity layer. Further, the film may comprise a middle-refractivity hard coat layer, a high-refractivity layer and a low-refractivity layer.

For example, JP-A-8-122504, JP-A-8-110401, JP-A-10-300902, JP-A-2002-243906, JP-A-2000-111706 are referred to. The constitutive layers may have other functions. For example, there are mentioned a stain-resistant low-refractivity layer and an antistatic high-refractivity layer (as in JP-A-10-206603, JP-A-2002-243906).

Preferably, the haze of the antireflection film is at most 5%, more preferably at most 3%. Also preferably, the strength of the film is at least H measured in the pencil hardness test according to JIS K5400, more preferably at least 2 H, most preferably at least 3 H.

### [High-Refractivity Layer and Middle-Refractivity Layer]

The high-refractivity layer of the antireflection film is formed of a cured film that contains at least ultrafine particles of an inorganic compound of high refractivity having a mean particle size of at most 100 nm and a matrix binder.

The high-refractivity inorganic compound particles are those of an inorganic compound having a refractivity of at least 1.65,preferably at least 1.9. The inorganic compound particles are, for example, those of a metal oxide with any of Ti, Zn, Sb, Sn, Zr, Ce, Ta, La and In, and those of a composite oxide with such metal atoms.

For example, the ultrafine particles may be processed with a surface-treating agent (e.g., silane coupling agent as in JP-A-11-295503, JP-A-11-153703, JP-A-2000-9908; anionic compound or organic metal coupling agent as in JP-A-2001-310432); or they may have a core/shell structure in which the core is a high-refractivity particle (e.g., as in JP-A-2001-166104); or they may be combined with a specific dispersant (e.g., as in JP-A-11-153703, U.S. Pat. No. 6,210,858, JP-A-2002-2776069).

The material to from the matrix may be any known thermoplastic resin or curable resin film.

For the material, also preferred is at least one composition selected from a polyfunctional compound-containing composition in which the compound has at least two radical-polymerizing and/or cationic-polymerizing groups, and a composition of a hydrolyzing group-containing organic metal compound or its partial condensate. For it, for example, referred to are the compounds described in JP-A-2000-47004, JP-A-2001-315242, JP-A-2001-31871, JP-A-2001-296401.

Also preferred is a curable film formed of a colloidal metal oxide obtained from a hydrolyzed condensate of a metal alkoxide, and a metal alkoxide composition. For example, it is described in JP-A-2001-293818.

The refractivity of the high-refractivity layer is generally from 1.70 to 2.20. Preferably, the thickness of the high-refractivity layer is from 5 nm to 10 μm, more preferably from 10 nm to 1 μm.

The refractivity of the middle-refractivity layer is so controlled that it may be between the refractivity of the low-refractivity layer and that of the high-refractivity layer. Preferably, the refractivity of the middle-refractivity layer is from 1.50 to 1.70.

### [Low-Refractivity Layer]

The low-refractivity layer is laminated on the high-refractivity layer in order. The refractivity of the low-refractivity layer may be, for example, from 1.20 to 1.55, but preferably from 1.30 to 1.50.

Preferably, the low-refractivity layer is constructed as the outermost layer having good scratch resistance and good stain resistance. For increasing the scratch resistance of the layer, it is effective to lubricate the surface of the layer. For it, for example, employable is a method of forming a thin layer that contains a conventional silicone compound or fluorine-containing compound introduced thereinto.

Preferably, the refractivity of the fluorine-containing compound is from 1.35 to 1.50, more preferably from 1.36 to 1.47. Also preferably, the fluorine-containing compound has a crosslinking or polymerizing functional group that contains a fluorine atom in an amount of from 35 to 80% by mass.

For example, herein usable are the compounds described in JP-A-9-222503, [0018] to [0026]; JP-A-11-38202, [0019] to [0030]; JP-A-2001-40284, [0027] to [0028]; JP-A-2000-284102; JP-A-2003-26732, [0012] to [0077]; and JP-A-2004-45462, [0030] to [0047].

Preferably, the silicone compound has a polysiloxane structure in which the polymer chain contains a curable functional group or a polymerizing functional group, and it forms a film having a crosslinked structure therein. For example, it includes reactive silicones (e.g., Silaplane (from Chisso)), and polysiloxanes double-terminated with a silanol group (as in JP-A-11-258403).

Preferably, the crosslinking or polymerizing group-having, fluorine-containing and/or siloxane polymer is crosslinked or polymerized simultaneously with or after the coating operation with the coating composition to form the outermost layer that contains a polymerization initiator and a sensitizer, by exposing the coating layer to light or heat.

Also preferred is a sol-gel curable film which comprises an organic metal compound such as a silane coupling agent and a specific fluorine-containing hydrocarbon group-having silane coupling agent and in which they are condensed in the presence of a catalyst to cure the film.

For example, there are mentioned a polyfluoroalkyl group-containing silane compound or its partial hydrolyzed condensate (as in JP-A-58-142958, JP-A-58-147483, JP-A-58-147484, JP-A-9-157582, JP-A-11-106704), and a silyl compound having a fluorine-containing long-chain group, poly(perfluoroalkylether) group (as in JP-A-2000-117902, JP-A-2001-48590, JP-A-2002-53804).

As other additives than the above, the low-refractivity layer may contain a filler (e.g., low-refractivity inorganic compound of which the primary particles have a mean particle size of from 1 to 150 nm, such as silicon dioxide (silica), fluorine-containing particles (magnesium fluoride, calcium fluoride, barium fluoride); organic fine particles described in JP-A-11-3820, [0020] to [0038]), a silane coupling agent, a lubricant, a surfactant, etc.

When the low-refractivity layer is positioned below an outermost layer, then it may be formed according to a vapor-phase process (e.g., vacuum evaporation, sputtering, ion plating, plasma CVD). However, a coating method is preferred as it produces the layer at low costs.

Preferably, the thickness of the low-refractivity layer is from 30 to 200 nm, more preferably from 50 to 150 nm, most preferably from 60 to 120 nm.

### [Hard Coat Layer]

A hard coat layer may be disposed on the surface of a transparent support for increasing the physical strength of the antireflection film to be thereon. In particular, the layer is preferably disposed between a transparent support and the above-mentioned high-refractivity layer.

Also preferably, the hard coat layer is formed through crosslinking or polymerization of an optical and/or thermal curable compound. The curable functional group is preferably a photopolymerizing functional group, and the hydrolyzing functional group-containing organic metal compound is preferably an organic alkoxysilyl compound. Specific examples of the compounds may be the same as those mentioned hereinabove for the high-refractivity layer. Specific examples of the constitutive composition for the hard coat layer are described in, for example, JP-A-2002-144913, JP-A-2000-9908, and WO0/46617.

The high-refractivity layer may serve also as a hard coat layer. In such a case, it is desirable that fine particles are added to and finely dispersed in the hard coat layer in the same manner as that mentioned hereinabove for the formation of the high-refractivity layer.

Containing particles having a mean particle size of from 0.2 to 10 μm, the hard coat layer may serve also as an antiglare layer (this will be mentioned hereinunder) having an antiglare function.

The thickness of the hard coat layer may be suitably determined in accordance with the use thereof. Preferably, for example, the thickness of the hard coat layer is from 0.2 to 10 μm, more preferably from 0.5 to 7 μm.

Preferably, the strength of the hard coat layer is at least H as measured in the pencil hardness test according to JIS K5400, more preferably at least 2 H, even more preferably at least 3 H. Also preferably, the abrasion of the test piece of the layer before and after the taper test according to JIS K5400 is as small as possible.

### [Front-Scattering Layer]

A front-scattering layer may be provided for improving the viewing angle on the upper and lower sides and on the right and left sides of liquid-crystal display devices to which the film is applied. Fine particles having a different refractivity may be dispersed in the hard coat layer, and the resulting hard coat layer may serve also as a front-scattering layer.

For it, for example, referred to are JP-A-11-38208 in which the front-scattering coefficient is specifically defined; JP-A-2000-199809 in which the relative refractivity of transparent resin and fine particles is defined to fall within a specific range; and JP-A-2002-107512 in which the haze value is defined to be at least 40%.

### [Other Layers]

In addition to the above-mentioned layers, the film may further has a primer layer, an antistatic layer, an undercoat layer, a protective layer, etc.

### [Coating Method]

The constitutive layers of the antireflection film may be formed in various coating methods of, for example, dip coating, air knife coating, curtain coating, roller coating, wire bar coating, gravure coating, microgravure coating or extrusion coating (as in U.S. Pat. No. 2,681,294).

### [Antiglare Function]

The antireflection film may have an antiglare function of scattering external light. The film may have the antiglare function by roughening its surface. When the antireflection film has the antiglare function, then its haze is preferably from 3 to 30%, more preferably from 5 to 20%, most preferably from 7 to 20%.

For roughening the surface of the antireflection film, employable is any method in which the roughened surface profile may be kept well. For example, there are mentioned a method of adding fine particles to a low-refractivity layer so as to roughen the surface of the layer (e.g., as in JP-A-2000-271878); a method of adding a small amount (from 0.1 to 50% by mass) of relatively large particles (having a particle size of from 0.05 to 2 μm) to the lower layer (high-refractivity layer, middle-refractivity layer or hard coat layer) below a low-refractivity layer to thereby roughen the surface of the lower layer, and forming a low-refractivity layer on it while keeping the surface profile of the lower layer (e.g., as in JP-A-2000-281410, JP-A-2000-95893, JP-A-2001-100004, 2001-281407); and a method of physically transferring a roughened profile onto the surface of the outermost layer (stain-resistant layer) (for example, according to embossing treatment as in JP-A-63-278839, JP-A-11-183710, JP-A-2000-275401).

Methods for analysis used in the invention are described below.

### (1) Polarizing Minor Impurities:

### (1-1) In Films:

After formed through melt casting or stretched, a film sample is observed with a 100-power polarization microscope in which the polarizing elements are set perpendicular to each other. The number of white impurities of from 1 μm to less than 100 μm in size that are seen through the observation is counted with the naked eye, and is represented per mm².

### (1-2) In Pellets:

i) Pellets are crushed with a hot press at 220° C. for 1 minute and formed into a sheet of about 100 μm in thickness.

ii) Then, this is observed with a polarization microscope under a cross-Nicol condition to count the number of white impurities of from 1 μm to less than 100 μm in size seen through the observation with the naked eye. From the thickness and the observed area of the sample, the number of the impurities is represented per the unit area (mm³).

### (2) Determination of Re and Rth:

The above film sample is conditioned at 25° C. and a relative humidity of 60% for 24 hours. Then, using an automatic birefringence meter (KOBRA-21ADH, by Oji Scientific Instruments), the sample is analyzed at 25° C. and a relative humidity of 60%, as follows: The vertical direction to the film surface and the slow axis of the film are taken as a rotation axis, and light having a wavelength of 550 nm is applied to the film in different inclination directions relative to the normal direction of the film, at intervals of 10 degrees between +50° and −50° from the normal direction, and different points of the film are analyzed to determine the retardation data. From these, the in-plane retardation (Re) and the thickness-direction retardation (Rth) are calculated. Unless otherwise specifically indicated, Re and Rth are the data measured in this manner.

### (3) Substitution Degree of Cellulose Acylate:

The substitution degree of cellulose acylate is obtained through 13C-NMR according to the method described in Carbohydr. Res. 273 (1995), 83-91 (Tezuka, et al.).

### (4) Black Impurities:

After formed through melt casting or stretched, a film sample is observed with a 100-power transmission microscope. The number of black impurities of from 1 μm to less than 100 μm in size that are seen through the observation is counted with the naked eye, and is represented per mm².

### (5) Yellowing:

After formed through melt casting or stretched, a film sample is analyzed with a spectrophotometer, based on air as the reference, to thereby determine the transmittance at 450 nm of the sample. The thickness of the sample is measured, and according to the Lambert-Beer law, the found data are converted into a unit transmittance (T450) per 100 μm, and this is the yellowing index of the sample.

### EXAMPLES

The invention is described more concretely with reference to the following Examples. In the following Examples, the material used, its amount and ratio, the details of the treatment and the treatment process may be suitably modified or changed not overstepping the spirit and the scope of the invention. Accordingly, the invention should not be limited to the Examples mentioned below.

### 1. Formation of Cellulose Acylate Film:

### (1) Preparation of Cellulose Acylate:

As in Table 1, cellulose acylates differing from each other in point of the type of the substituted acyl group and of the substitution degree were prepared. For preparing these cellulose acylates, sulfuric acid was used as a catalyst (in an amount of 7.8 parts by mass relative to 100 parts by mass of cellulose), and a carboxylic acid for the acyl substitution was added, and the acylation was effected at 40° C. In this process, the type and the amount of the carboxylic acid used were varied to prepare various cellulose acylates having a different acyl group and having a different substitution degree.

After the acylation, the polymer was ripened at 40° C. Thus obtained, the degree of polymerization of the cellulose acylates was determined according to the method mentioned below. The results are given in Table 1 (the same shall apply hereinunder)

### (Determination of Degree of Polymerization)

About 0.2 g of an absolutely-dried cellulose acylate was accurately measured, and dissolved in 100 ml of a mixed solvent of methylene chloride/ethanol=9/1 (by mass). Using an Ostwald's viscometer at 25° C., the time (sec) taken by it to drop was determined, from which the degree of polymerization DP of the sample was obtained according to the following formulae:

ηᵣₑₗ=T/T₀

[η]=(ln ηᵣₑₗ)/C

DP=[η]/Km

wherein:
T means the time (sec) taken by the sample to drop;
T₀ means the time (sec) taken by the solvent alone to drop;
C means the concentration of the sample (g/l);
Km is 6×10⁻⁴.

### (2) Pelletization of Cellulose Acylate:

The above cellulose acylate was dried at 120° C. for 3 hours to have a water content of 0.1% by mass, to which was added any of the following plasticizers. Further, silicon dioxide particles (Aerosil R972V) were added to all of these in an amount of 0.05% by mass.
Plasticizer A: the following plasticizer,

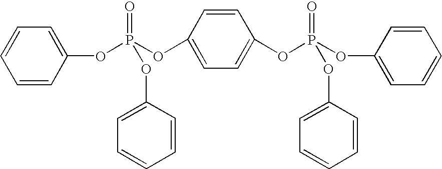

Plasticizer B: triphenyl phosphate,
Plasticizer C: dimethyl phthalate,
Plasticizer D: dioctyl adipate,
Plasticizer E: glycerin diacetate monooleate,
Plasticizer F: polyethylene glycol (molecular weight, 600).

The resulting mixture was put into the hopper of a double-screw kneading extruder, and kneaded under the pelletization condition shown in Table 2. The double-screw kneading extruder was provided with a vacuum vent, through which the device was degassed in vacuum (set at 30 kPa). The screw of the double-screw kneading extruder had a compression ratio of 3; the barrel diameter thereof was 40 mm; L/D=40; and the extrusion rate from the extruder was 150 kg/hr.

After thus melted, the cellulose acylate was extruded out into a water bath having a strand solidification temperature as in Table 2, as strands having a diameter of 3 mm, then dipped for 1 minutes therein (for strand solidification), and thereafter led to pass through water at 10° C. for 30 seconds so as to lower their temperature, and then cut into a length of 5 mm. Thus prepared, the pellets were dried at 100° C. for 10 minutes.

Tg of the pellets obtained in the manner as above was measured as follows:

### (Tg Measurement)

20 mg of the sample was put into a sample pan of DSC. In a nitrogen atmosphere, this was heated from 30° C. up to 250° C. at a rate of 10° C./min (1st run), and then cooled down to 30° C. at a rate of −10° C./min. Next, this was again heated from 30° C. up to 250° C. at a rate of 10° C./min (2nd run). The temperature at which the base line obtained in the 2nd run began to deviate from the low-temperature side was read, and this is Tg (° C.) of the sample.

Thus obtained, the cellulose acylate pellets were analyzed for polarizing minor impurities therein according to the method mentioned above, and the data are given in Table 2. The samples of the invention had few polarizing minor impurities and were good.

### (3) Melt Film Formation:

The cellulose acylate pellets prepared in the above method were dried in a vacuum drier at 110° C. for 3 hours. These were put into a hopper controlled at (Tg−10)° C., and melted at 190° C., taking 5 minutes. The resulting melt was filtered before a die, according to a method selected from the following:

(The filtration methods (a) and (b) are described in Table 3.)
a) Screen mesh (100 μm),
b) depth filter (5 μm),
c) depth filter (50 μm),
d) screen mesh (70 μm).

In Comparative Example 9, employed was the filtration method (b) according to the more preferred mode described in [0046] in JP-A-2000-352620.

Films were formed under the condition of T/D ratio (lip distance/formed film thickness) and die-casting drum (CD) distance (the CD-die distance was divided by the film width, and this is expressed as percentage), as in Table 3. In this stage, the speed of the casting drum was T/D times the extrusion speed, and films having a desired thickness (D) were obtained. The temperature at both edges of the die was kept higher than that at the center thereof by the temperature difference (° C.) between the edges and the center of the die in Table 3. When the temperature at the die edges was kept higher by from 1 to 20° C., then the films formed did not crack at the edges thereof; but when it was higher by less than 1° C. (in Comparative Example 3, Comparative Example 9), the films cracked at their edges, and when it was higher by more than 20° C., then the resin was thermally decomposed and the films colored at their edges (Example 28 of the invention).

The casting drum was set at Tg−10° C., on which the film was solidified. In this stage, employed was a level-dependent electrostatic charging method (where a 10-kV wire was disposed at 10 cm from the melt landing point on the casting drum). The solidified melt was peeled off, and trimmed at both edges (each 5% of the overall width) just before wound up. Then, this was knurled at both sides by a width of 10 mm and a height of 50 μm, and wound up for 3000 m at a speed of 30 m/min. At each level, the width of the thus-obtained unstretched film was 1.5 m; and the thickness thereof was shown in Table 3.

Thus obtained, the unstretched cellulose acylate films were analyzed for the polarizing minor impurities therein, etc., according to the methods mentioned above. The samples of the invention were all good. However, the samples overstepping the invention had poor optical properties (light leakage, black impurities, increase in yellowing, as in Table 3). In particular, Comparative Example 9 corresponds to the sample No. 11 in the examples in JP-A-2000-352620, and the number of the polarizing minor impurities therein was large, and Rth of the film was low. In addition, the film contained many black impurities and its yellowing was large.

When Example 3 of the invention is compared with Comparative Examples 1, 1B and 1C, then it is recognized that the polarizing minor impurities were reduced both in the formed film and the stretched film even though an extremely rough filter was used, since the number of the polarizing minor impurities originally existing in the pellets was small. On the other hand, in Comparative Example 1, both the formed film and the stretched film had many polarizing minor impurities since the pellets originally contained many polarizing minor impurities. When a fine 5- or 50-μm filter (filtration method b, c in Table 3) was used, the minor impurities were reduced but insufficiently. In this, in addition, the black impurities in the film increased and the film much yellowed owing to the thermal degradation in the residence zone. To that effect, the invention has succeeded in solving the problem that could not be solved by filtration, by specifically designing the pelletization step. The same results were obtained also in Example 29 of the invention, and Comparative Examples 10 and 10B.

### (4) Stretching:

The unstretched films were stretched at the ratio shown in Table 3. Then, they were trimmed by 5% at both sides. The resulting stretched films were analyzed for their physical properties (Rth, Re and polarizing minor impurities). The films were stretched at a temperature higher by 10° C. than Tg measured in the above, at 300%/min.

### 2. Construction of Polarizer:

### (1) Saponification of Cellulose Acylate Film:

The unstretched and stretched cellulose acylate films were saponified according to a dipping saponification method mentioned below.

### (1-1) Dipping Saponification:

An aqueous NaOH solution (1.5 mol/L) was used as a saponifying liquid. This was conditioned at 60° C., and the cellulose acylate film was dipped therein for 2 minutes. Next, the film was dipped in an aqueous sulfuric acid solution (0.05 mol/L) for 30 seconds, and then led to pass through a water bath.

### (1-2) Coating Saponification:

20 parts by mass of water was added to 80 parts by mass of iso-propanol, and KOH was dissolved therein to make the solution have a normality of 1.5. Then, this was conditioned at 60° C. and used as a saponifying liquid.

The saponifying liquid was applied onto the cellulose acylate film at 60° C. in an amount of 10 g/m², to saponify the film for 1 minute. Next, a hot water spray at 50° C. was applied to it at a rate of 10 L/m²·min for 1 minute.

The same was obtained in any of the above saponification modes.

### (2) Formation of Polarizing Film:

According to Example 1 in JP-A-2001-141926, a film was stretched in the machine direction between two pairs of nip rolls rotating at a different peripheral speed.

### (3) Lamination:

Thus obtained, the polarizing film was laminated with any of the saponified, unstretched or stretched cellulose acylate film or a saponified Fujitac TD80U (unstretched triacetate film) in the following combination, using an aqueous 3% PVA (Kuraray's PVA-117H) solution as an adhesive, in such a manner that the polarization axis could cross the machine direction of the cellulose acylate film at 45 degrees.
Polarizer A: stretched cellulose acylate film/polarizing film/unstretched cellulose acylate film,
Polarizer B: stretched cellulose acylate film/polarizing film/Fujitac TD80U,
Polarizer C: stretched cellulose acylate film/polarizing film/stretched cellulose acylate film,
Polarizer D: unstretched cellulose acylate film/polarizing film/Fujitac TD80U,
Polarizer E: unstretched cellulose acylate film/polarizing film/unstretched cellulose acylate film,

The unstretched cellulose acylate film in the polarizer A is an unstretched film that is on the same level as that of the stretched one.

The unstretched cellulose acylate films on both sides of the polarizer E were the same.

### 3. Construction of Optical Compensatory Film, Liquid-Crystal Display Device:

In a 15-inch display, VL-1530S (by Fujitsu, VA-mode), the polarizer was replaced by any of the above polarizers A to E. In this, when the polarizer D or E was used, then the stretched film of Example 1 of the invention, serving as a retardation film, was sandwiched between the polarizer and the liquid-crystal layer. The polarizer A to D was disposed on one side or on both sides of the liquid-crystal layer. Thus constructed, the liquid-crystal display devices were tested for the degree of leakage, the yellowing and the amount of black impurities, according to the methods mentioned below.

### (Method of Determining Light Leakage)

The liquid-crystal display device was kept for black display on its entire panel, in a pitch-dark room. In this condition, the brightness of the panel was measured with a photometer. The value of the quantity of light was divided by the value thereof at the time of white level of display on the entire panel of the device, and expressed in terms of percentage. This is the light leakage (%) from the device.

The light leakage from the devices with any of the retardation polarizers A to E that comprises the stretched cellulose acylate film of the invention was small, in which the optical compensatory films were all good. On the other hand, however, the light leakage from the devices not falling within the scope of the invention was significant. In particular, the light leakage from the device where the film corresponds to the sample No. 11 in the examples in JP-A-2000-352620 (Comparative Example 9 in Table 3) was remarkable. This was more obvious when the sample was compared with Example 23. In Examples 29 to 31 of the invention, the unstretched cellulose acylate film was used in the polarizer. Re of these unstretched cellulose acylate was from 0 to 10 nm; and Rth thereof was from 0 to 15 nm. Since their Re and Rth were low, the light leakage from the devices increased as compared with that in the device of Example 32 of the invention where the stretched film was used, but it causes no problem in practical use.

### (Yellowing)

The liquid-crystal display device was kept for white display on its entire panel, in a pitch-dark room. In this condition, the luminous intensity of the panel at 450 nm and 550 nm was measured. The ratio of the data (luminous intensity at 450 nm/luminous intensity at 550 nm) is the index of yellowing (E450). Specifically, when the yellowing becomes stronger, then the luminous intensity of the complementary blue color (450 nm) lowers and the value standardized at 550 nm becomes smaller.

The yellowing of the devices with any of the polarizers A to E of the invention was small, in which the optical compensatory films were all good. On the other hand, however, the yellowing of the devices not falling within the scope of the invention was significant. In particular, the yellowing of the device where the film corresponds to the sample No. 11 in the examples in JP-A-2000-352620 (Comparative Example 9 in Table 3) was remarkable. This was more obvious when the sample was compared with Example 23.

### (Amount of Black Impurities)

The liquid-crystal display device was kept for white display on its entire panel, and the number of black spots (black impurities) in a square of 10 cm×10 cm was counted with a 100-power loupe. This is the number of black impurities per the unit area (mm²). The number of black impurities in the devices with any of the polarizers A to E of the invention was small, in which the optical compensatory films were all good. On the other hand, however, the number of black impurities in the devices not falling within the scope of the invention was large. In particular, the number of black impurities in the device where the film corresponds to the sample No. 11 in the examples in JP-A-2000-352620 (Comparative Example 9 in Table 3) was especially great. This was more obvious when the sample was compared with Example 23. In Table 1, “temperature difference between the edges and the center of die” is a value computed by subtracting the temperature at the center of the die from that at the edges thereof.

Using the unstretched film of Examples 1 and 16 of the invention, the polarizers D and E were constructed. With the polarizer fitted onto one side thereof, the devices were tested. All the devices were good in that the light leakage from them was 4%, the number of black impurities therein was 0, and the yellowing of the devices was 0.96.

Pellets were prepared in the same manner as in Example 1 of the invention, in which, however, the butyryl group was 1.4 and the acetyl group was 1.4. The number of impurities in these pellets was 0/mm³. These were formed into an unstretched film. In the unstretched film, the number of polarizing minor impurities was 0/mm², the number of black impurities was 0/mm², and the yellowing of the film was 93%. Using this, the polarizers D and E were constructed. With the polarizer fitted onto one side thereof, the devices were tested. All the devices were good in that the light leakage from them was 4%, the number of black impurities therein was 0, and the yellowing of the devices was 0.96.

TABLE 1

| | Cellulose Acylate | | | | | | | | | |
|---|---|---|---|---|---|---|---|---|---|---|
| | Substitution Degree | | | | | | | | Plasticizer | |
| | | Propionyl | | | | | | | | Amount |
| | Acetyl | Group | Butyryl | Pentanoyl | Hexanoyl | Y (total of | | Degree of | | Added |
| | Group (X) | (Y1) | Group (Y2) | Group (Y3) | Group (Y4) | Y1 to Y4) | X + Y | Polymerization | Type | (wt. %) |
| 1 - the invention | 1.0 | | 1.7 | | | 1.7 | 2.7 | 300 | no | 0 |
| 2 - the invention | 1.0 | | 1.7 | | | 1.7 | 2.7 | 300 | no | 0 |
| 3 - the invention | 1.0 | | 1.7 | | | 1.7 | 2.7 | 300 | no | 0 |
| Comparative Example 1 | 1.0 | | 1.7 | | | 1.7 | 2.7 | 300 | no | 0 |
| Comparative Example 1B | 1.0 | | 1.7 | | | 1.7 | 2.7 | 300 | no | 0 |
| Comparative Example 1C | 1.0 | | 1.7 | | | 1.7 | 2.7 | 300 | no | 0 |
| 1B - the invention | 1.0 | | 1.7 | | | 1.7 | 2.7 | 300 | no | 0 |
| 4 - the invention | 1.0 | | 1.7 | | | 1.7 | 2.7 | 300 | no | 0 |
| 5 - the invention | 1.0 | | 1.7 | | | 1.7 | 2.7 | 300 | no | 0 |
| 6 - the invention | 1.0 | | 1.7 | | | 1.7 | 2.7 | 300 | no | 0 |
| 6B - the invention | 1.0 | | 1.7 | | | 1.7 | 2.7 | 300 | no | 0 |
| 7 - the invention | 1.0 | | 1.7 | | | 1.7 | 2.7 | 300 | no | 0 |
| 8 - the invention | 1.0 | | 1.7 | | | 1.7 | 2.7 | 300 | no | 0 |
| 9 - the invention | 1.0 | | 1.7 | | | 1.7 | 2.7 | 300 | no | 0 |
| 9B - the invention | 1.0 | | 1.7 | | | 1.7 | 2.7 | 300 | no | 0 |
| 10 - the invention | 1.0 | | 1.7 | | | 1.7 | 2.7 | 300 | no | 0 |
| 11 - the invention | 1.0 | | 1.7 | | | 1.7 | 2.7 | 300 | no | 0 |
| 12 - the invention | 1.0 | | 1.7 | | | 1.7 | 2.7 | 300 | no | 0 |
| 12B - the invention | 1.0 | | 1.7 | | | 1.7 | 2.7 | 300 | no | 0 |
| 13 - the invention | 0.2 | 2.5 | | | | 2.5 | 2.7 | 250 | B | 6 |
| 14 - the invention | 0.2 | 2.5 | | | | 2.5 | 2.7 | 250 | B | 6 |
| 15 - the invention | 0.2 | 2.5 | | | | 2.5 | 2.7 | 250 | B | 6 |
| Comparative Example 5 | 0.2 | 2.5 | | | | 2.5 | 2.7 | 250 | B | 6 |
| 16 - the invention | 0.7 | | 2.3 | | | 2.3 | 3.0 | 350 | D | 8 |
| 17 - the invention | 0.7 | | 2.3 | | | 2.3 | 3.0 | 350 | D | 8 |
| 18 - the invention | 0.7 | | 2.3 | | | 2.3 | 3.0 | 350 | D | 8 |
| Comparative Example 6 | 0.7 | | 2.3 | | | 2.3 | 3.0 | 350 | D | 8 |
| 19 - the invention | 1.8 | 0.7 | | 0.2 | 0.2 | 1.1 | 2.9 | 400 | A | 2 |
| Comparative Example 7 | 1.8 | 0.7 | | 0.2 | 0.2 | 1.1 | 2.9 | 400 | A | 2 |
| 20 - the invention | | 2.9 | | | | 2.9 | 2.9 | 200 | C | 12 |
| 21 - the invention | | 2.9 | | | | 2.9 | 2.9 | 200 | C | 12 |
| 22 - the invention | | 2.9 | | | | 2.9 | 2.9 | 200 | C | 12 |
| Comparative Example 8 | | 2.9 | | | | 2.9 | 2.9 | 200 | C | 12 |
| Comparative Example 9 | 0.2 | | 2.5 | | | 2.5 | 2.7 | 100 | no | 0 |
| 23 - the invention | 0.2 | | 2.5 | | | 2.5 | 2.7 | 100 | no | 0 |
| 24 - the invention | 1.0 | | 1.7 | | | 1.7 | 2.7 | 300 | no | 0 |
| 25 - the invention | 1.0 | | 1.7 | | | 1.7 | 2.7 | 300 | no | 0 |
| 26 - the invention | 1.0 | | 1.7 | | | 1.7 | 2.7 | 300 | no | 0 |
| 27 - the invention | 1.0 | | 1.7 | | | 1.7 | 2.7 | 300 | no | 0 |
| 28 - the invention | 1.0 | | 1.7 | | | 1.7 | 2.7 | 300 | no | 0 |
| 29 - the invention | 1.1 | 1.8 | | | | 1.8 | 2.9 | 200 | E | 8 |
| 30 - the invention | 0.1 | 2.6 | | | | 2.6 | 2.7 | 230 | F | 5 |
| 31 - the invention | 1.5 | 1.0 | | | | 1.0 | 2.5 | 180 | no | 0 |
| Comparative Example 10 | 1.1 | 1.8 | | | | 1.8 | 2.9 | 200 | no | 0 |
| Comparative Example 10B | 1.1 | 1.8 | | | | 1.8 | 2.9 | 200 | no | 0 |
| 32 - the invention | 1.1 | 1.8 | | | | 1.8 | 2.9 | 200 | no | 0 |

TABLE 2

| | Pelletization Condition | | | | | | |
|---|---|---|---|---|---|---|---|
| | | Screw | | | | Polarizing Minor | |
| | Temperature | Revolution | Residence | Vacuum | Strand Solidification | impurities in | |
| | (° C.) | (rpm) | time (sec) | Degassification | Temperature (° C.) | Pellets (/mm³) | Tg (° C.) |
| 1 - the invention | 155 | 260 | 60 | yes | 45 | 0 | 136 |
| 2 - the invention | 185 | 260 | 60 | yes | 45 | 0 | 136 |
| 3 - the invention | 215 | 260 | 60 | yes | 45 | 8 | 136 |
| Comparative Example 1 | 225 | 260 | 60 | yes | 45 | 220 | 136 |
| Comparative Example 1B | 225 | 260 | 60 | yes | 45 | 220 | 136 |
| Comparative Example 1C | 225 | 260 | 60 | yes | 45 | 220 | 136 |
| 1B - the invention | 215 | 260 | 60 | yes | 45 | 8 | 136 |
| 4 - the invention | 170 | 200 | 80 | yes | 40 | 0 | 136 |
| 5 - the invention | 170 | 200 | 80 | yes | 40 | 0 | 136 |
| 6 - the invention | 170 | 200 | 80 | yes | 40 | 0 | 136 |
| 6B - the invention | 170 | 200 | 80 | yes | 40 | 0 | 136 |
| 7 - the invention | 170 | 200 | 80 | yes | 40 | 0 | 136 |
| 8 - the invention | 170 | 200 | 80 | yes | 40 | 0 | 136 |
| 9 - the invention | 170 | 200 | 80 | yes | 40 | 0 | 136 |
| 9B - the invention | 170 | 200 | 80 | yes | 40 | 0 | 136 |
| 10 - the invention | 180 | 650 | 30 | yes | 60 | 0 | 136 |
| 11 - the invention | 180 | 650 | 30 | yes | 60 | 0 | 136 |
| 12 - the invention | 180 | 650 | 30 | yes | 60 | 0 | 136 |
| 12B - the invention | 180 | 650 | 30 | yes | 60 | 0 | 136 |
| 13 - the invention | 190 | 120 | 160 | yes | 70 | 18 | 115 |
| 14 - the invention | 190 | 450 | 20 | yes | 70 | 0 | 115 |
| 15 - the invention | 190 | 780 | 15 | yes | 70 | 25 | 115 |
| Comparative Example 5 | 190 | 90 | 10 | yes | 70 | 195 | 115 |
| 16 - the invention | 170 | 700 | 8 | yes | 55 | 0 | 73 |
| 17 - the invention | 170 | 350 | 120 | yes | 55 | 0 | 73 |
| 18 - the invention | 170 | 110 | 170 | yes | 55 | 23 | 73 |
| Comparative Example 6 | 170 | 100 | 190 | yes | 55 | 155 | 73 |
| 19 - the invention | 190 | 360 | 40 | yes | 45 | 0 | 175 |
| Comparative Example 7 | 190 | 360 | 40 | no | 45 | 165 | 175 |
| 20 - the invention | 200 | 200 | 100 | yes | 32 | 16 | 122 |
| 21 - the invention | 200 | 200 | 100 | yes | 60 | 0 | 122 |
| 22 - the invention | 200 | 200 | 100 | yes | 88 | 0 | 122 |
| Comparative Example 8 | 200 | 200 | 100 | yes | 25 | 187 | 122 |
| Comparative Example 9 | 245 | 35 | 420 | no | 15 | 278 | 135 |
| 23 - the invention | 170 | 200 | 80 | yes | 45 | 1 | 135 |
| 24 - the invention | 170 | 200 | 80 | yes | 40 | 0 | 136 |
| 25 - the invention | 170 | 200 | 80 | yes | 40 | 0 | 136 |
| 26 - the invention | 170 | 200 | 80 | yes | 40 | 0 | 136 |
| 27 - the invention | 170 | 200 | 80 | yes | 40 | 0 | 136 |
| 28 - the invention | 170 | 200 | 80 | yes | 40 | 0 | 136 |
| 29 - the invention | 175 | 300 | 45 | yes | 50 | 0 | 121 |
| 30 - the invention | 165 | 200 | 30 | yes | 40 | 0 | 115 |
| 31 - the invention | 185 | 400 | 60 | yes | 60 | 0 | 135 |
| Comparative Example 10 | 175 | 80 | 45 | yes | 50 | 250 | 128 |
| Comparative Example 10B | 175 | 80 | 45 | yes | 50 | 250 | 128 |
| 32 - the invention | 175 | 300 | 45 | yes | 50 | 0 | 128 |

TABLE 3

| | Formation of Unstretched Film | | | | | | | |
|---|---|---|---|---|---|---|---|---|
| | | Temperature | Die-CD | | | Polarizing | | |
| | | Difference between | Distance (to | | | Minor | Black | Yellowing |
| | | Edges and Center | overall width) | Thickness | Filtration | Impurities | Impurities | (T450) |
| | T/D | of Die (° C.) | (%) | (μm) | Method | (/mm²) | (/mm²) | (%) |
| 1 - the invention | 8 | 5 | 15 | 150 | a | 0 | 0 | 93 |
| 2 - the invention | 8 | 5 | 15 | 150 | a | 0 | 0 | 93 |
| 3 - the invention | 8 | 5 | 15 | 150 | a | 1 | 0 | 92 |
| Comparative Example 1 | 8 | 5 | 15 | 150 | a | 25 | 0 | 92 |
| Comparative Example 1B | 8 | 5 | 15 | 150 | b | 10 | 55 | 83 |
| Comparative Example 1C | 8 | 5 | 15 | 150 | c | 21 | 35 | 86 |
| 1B - the invention | 8 | 5 | 15 | 150 | d | 0 | 8 | 90 |
| 4 - the invention | 2 | 8 | 12 | 130 | a | 1 | 0 | 93 |
| 5 - the invention | 5 | 8 | 12 | 130 | a | 0 | 0 | 93 |
| 6 - the invention | 9 | 8 | 12 | 130 | a | 0 | 0 | 92 |
| 6B - the invention | 1 | 8 | 12 | 130 | a | 5 | 2 | 91 |
| 7 - the invention | 4 | 1 | 10 | 80 | a | 2 | 0 | 93 |
| 8 - the invention | 4 | 9 | 10 | 80 | a | 0 | 0 | 93 |
| 9 - the invention | 4 | 19 | 10 | 80 | a | 0 | 0 | 92 |
| 9B - the invention | 4 | 0 | 10 | 80 | a | 7 | 3 | 92 |
| 10 - the invention | 7 | 10 | 1 | 120 | a | 0 | 0 | 93 |
| 11 - the invention | 7 | 10 | 10 | 120 | a | 0 | 0 | 92 |
| 12 - the invention | 7 | 10 | 20 | 120 | a | 1 | 0 | 92 |
| 12B - the invention | 7 | 10 | 30 | 120 | a | 3 | 2 | 92 |
| 13 - the invention | 6 | 3 | 8 | 100 | a | 2 | 0 | 95 |
| 14 - the invention | 6 | 3 | 8 | 100 | a | 0 | 0 | 95 |
| 15 - the invention | 6 | 3 | 8 | 100 | a | 2 | 0 | 94 |
| Comparative Example 5 | 6 | 3 | 8 | 100 | a | 18 | 2 | 92 |
| 16 - the invention | 7 | 15 | 7 | 35 | a | 0 | 0 | 96 |
| 17 - the invention | 7 | 15 | 7 | 35 | a | 0 | 0 | 95 |
| 18 - the invention | 7 | 15 | 7 | 35 | a | 2 | 0 | 93 |
| Comparative Example 6 | 7 | 15 | 7 | 35 | a | 16 | 3 | 91 |
| 19 - the invention | 5 | 7 | 12 | 380 | a | 0 | 0 | 95 |
| Comparative Example 7 | 5 | 7 | 12 | 380 | a | 14 | 2 | 94 |
| 20 - the invention | 3 | 12 | 8 | 120 | a | 2 | 0 | 95 |
| 21 - the invention | 3 | 12 | 8 | 120 | a | 0 | 0 | 95 |
| 22 - the invention | 3 | 12 | 8 | 120 | a | 0 | 0 | 94 |
| Comparative Example 8 | 3 | 12 | 8 | 120 | a | 16 | 0 | 91 |
| Comparative Example 9 | 1.2 | 0 | 30 | 80 | b | 25 | 68 | 79 |
| 23 - the invention | 5 | 6 | 12 | 80 | a | 0 | 0 | 91 |
| 24 - the invention | 4 | 4 | 6 | 110 | a | 0 | 0 | 93 |
| 25 - the invention | 4 | 4 | 6 | 110 | a | 0 | 0 | 93 |
| 26 - the invention | 4 | 4 | 6 | 110 | a | 0 | 0 | 92 |
| 27 - the invention | 4 | 4 | 6 | 110 | a | 0 | 0 | 92 |
| 28 - the invention | 4 | 23 | 10 | 80 | a | 3 | 3 | 91 |
| 29 - the invention | 7 | 8 | 10 | 80 | a | 0 | 0 | 95 |
| 30 - the invention | 5 | 4 | 16 | 60 | a | 0 | 0 | 96 |
| 31 - the invention | 9 | 16 | 5 | 100 | a | 0 | 0 | 93 |
| Comparative Example 10 | 7 | 8 | 10 | 80 | a | 29 | 0 | 95 |
| Comparative Example 10B | 7 | 8 | 10 | 80 | b | 10 | 45 | 82 |
| 32 - the invention | 7 | 8 | 10 | 80 | a | 0 | 0 | 95 |

TABLE 4

| | Stretching | | | | | | | | | | | |
|---|---|---|---|---|---|---|---|---|---|---|---|---|
| | Condition | | Physical Properties of Stretched Film | | | | | | Liquid-Crystal Display Device | | | |
| | MD | Td | | | Polarizing | | | | | | | Yellow- |
| | Draw | Draw | | | Minor | Black | Yellowing | Layer | | Light | Black | ing |
| | Ratio | Ratio | Rth | Re | impurities | impurities | (T450) | Constitution | | Leakage | impurities | (T450) |
| | (%) | (%) | (nm) | (nm) | (/mm²) | (/mm²) | (%) | of Polarizer | Fitting | (%) | (/mm²) | (—) |
| 1 - the invention | 50 | 50 | 250 | 40 | 0 | 0 | 95 | polarizer B | one side | 0 | 0 | 0.96 |
| 2 - the invention | 50 | 50 | 250 | 40 | 0 | 0 | 94 | polarizer B | one side | 0 | 0 | 0.96 |
| 3 - the invention | 50 | 50 | 250 | 40 | 1 | 0 | 94 | polarizer B | one side | 1 | 0 | 0.95 |
| Comparative Example 1 | 50 | 50 | 250 | 40 | 18 | 0 | 90 | polarizer B | one side | 10 | 0 | 0.92 |
| Comparative Example 1B | 50 | 50 | 250 | 40 | 8 | 45 | 83 | polarizer B | one side | 6 | 45 | 0.82 |
| Comparative Example 1C | 50 | 50 | 250 | 40 | 14 | 31 | 87 | polarizer B | one side | 11 | 35 | 0.85 |
| 1B - the invention | 50 | 50 | 250 | 40 | 0 | 7 | 90 | polarizer B | one side | 10 | 7 | 0.90 |
| 4 - the invention | 20 | 100 | 200 | 160 | 1 | 0 | 93 | polarizer A | one side | 0 | 0 | 0.95 |
| 5 - the invention | 20 | 100 | 250 | 160 | 0 | 0 | 93 | polarizer A | one side | 0 | 0 | 0.95 |
| 6 - the invention | 20 | 100 | 350 | 170 | 0 | 0 | 92 | polarizer A | one side | 0 | 0 | 0.94 |
| 6B - the invention | 20 | 100 | 90 | 140 | 4 | 2 | 90 | polarizer A | one side | 8 | 2 | 0.91 |
| 7 - the invention | 70 | 70 | 360 | 30 | 0 | 0 | 93 | polarizer A | one side | 0 | 0 | 0.95 |
| 8 - the invention | 70 | 70 | 400 | 30 | 0 | 0 | 92 | polarizer A | one side | 0 | 0 | 0.94 |
| 9 - the invention | 70 | 70 | 420 | 30 | 0 | 0 | 91 | polarizer A | one side | 0 | 0 | 0.93 |
| 9B - the invention | 70 | 70 | 80 | 30 | 6 | 2 | 90 | polarizer A | one side | 12 | 2 | 0.91 |
| 10 - the invention | 300 | 10 | 260 | 280 | 0 | 0 | 93 | polarizer B | one side | 0 | 0 | 0.94 |
| 11 - the invention | 300 | 10 | 230 | 280 | 0 | 0 | 92 | polarizer B | one side | 0 | 0 | 0.93 |
| 12 - the invention | 300 | 10 | 190 | 280 | 1 | 0 | 91 | polarizer B | one side | 0 | 0 | 0.94 |
| 12B - the invention | 300 | 10 | 80 | 280 | 2 | 2 | 90 | polarizer B | one side | 8 | 2 | 0.91 |
| 13 - the invention | 30 | 40 | 140 | 80 | 1 | 0 | 95 | polarizer C | one side | 0 | 0 | 0.97 |
| 14 - the invention | 30 | 40 | 140 | 80 | 0 | 0 | 95 | polarizer C | one side | 0 | 0 | 0.97 |
| 15 - the invention | 30 | 40 | 140 | 80 | 0 | 0 | 93 | polarizer C | one side | 0 | 0 | 0.95 |
| Comparative Example 5 | 30 | 40 | 140 | 80 | 16 | 2 | 91 | polarizer C | one side | 8 | 2 | 0.91 |
| 16 - the invention | 250 | 150 | 750 | 220 | 0 | 0 | 96 | polarizer B | one side | 0 | 0 | 0.96 |
| 17 - the invention | 250 | 150 | 750 | 220 | 0 | 0 | 94 | polarizer B | one side | 0 | 0 | 0.96 |
| 18 - the invention | 250 | 150 | 750 | 220 | 1 | 0 | 93 | polarizer B | one side | 1 | 0 | 0.95 |
| Comparative Example 6 | 250 | 150 | 750 | 220 | 14 | 3 | 91 | polarizer B | one side | 8 | 3 | 0.91 |
| 19 - the invention | 10 | 50 | 110 | 80 | 0 | 0 | 95 | polarizer B | both sides | 0 | 0 | 0.97 |
| Comparative Example 7 | 10 | 50 | 110 | 80 | 12 | 2 | 93 | polarizer B | both sides | 8 | 2 | 0.94 |
| 20 - the invention | 100 | 100 | 400 | 20 | 1 | 0 | 96 | polarizer B | one side | 1 | 0 | 0.97 |
| 21 - the invention | 100 | 100 | 400 | 20 | 0 | 0 | 95 | polarizer B | one side | 0 | 0 | 0.96 |
| 22 - the invention | 100 | 100 | 400 | 20 | 0 | 0 | 93 | polarizer B | one side | 0 | 0 | 0.96 |
| Comparative Example 8 | 100 | 100 | 400 | 20 | 14 | 0 | 91 | polarizer B | one side | 8 | 0 | 0.94 |
| Comparative Example 9 | 50 | 50 | 80 | 3 | 22 | 55 | 77 | polarizer C | one side | 20 | 57 | 0.77 |
| 23 - the invention | 50 | 50 | 270 | 3 | 0 | 0 | 91 | polarizer C | one side | 0 | 0 | 0.95 |
| 24 - the invention | 45 | 45 | 200 | 10 | 0 | 0 | 92 | polarizer B | one side | 3 | 0 | 0.95 |
| 25 - the invention | 50 | 40 | 200 | 30 | 0 | 0 | 93 | polarizer B | one side | 0 | 0 | 0.95 |
| 26 - the invention | 200 | 30 | 500 | 280 | 0 | 0 | 91 | polarizer B | one side | 0 | 0 | 0.94 |
| 27 - the invention | 240 | 20 | 500 | 320 | 0 | 0 | 91 | polarizer B | one side | 3 | 0 | 0.94 |
| 28 - the invention | 70 | 70 | 550 | 30 | 2 | 2 | 91 | polarizer A | one side | 3 | 2 | 0.90 |
| 29 - the invention | 10 | 50 | 200 | 80 | 0 | 0 | 0 | polarizer D | one side | 3 | 0 | 0.98 |
| 30 - the invention | 15 | 75 | 250 | 100 | 0 | 0 | 0 | polarizer E | one side | 3 | 0 | 0.97 |
| 31 - the invention | 20 | 100 | 300 | 120 | 0 | 0 | 0 | polarizer D | both sides | 3 | 0 | 0.97 |
| Comparative Example 10 | 10 | 50 | 200 | 80 | 25 | 0 | 0 | polarizer D | one side | 13 | 0 | 0.98 |
| Comparative Example 10B | 10 | 50 | 200 | 80 | 8 | 40 | 83 | polarizer D | one side | 8 | 43 | 0.81 |
| 32 - the invention | 10 | 50 | 200 | 80 | 0 | 0 | 0 | polarizer A | one side | 0 | 0 | 0.99 |

When the unstretched or stretched cellulose acylate film of the invention was used in place of the liquid-crystal layer-coated cellulose acetate film in Example 1 in JP-A-11-316378, then good optical compensatory films were produced.

Similarly, when the unstretched or stretched cellulose acylate film of the invention was used in place of the liquid-crystal layer-coated cellulose acetate film in Example 1 in JP-A-7-333433, then good optical compensatory filter films were produced.

When the polarizer or the retardation polarizer of the invention was used in the liquid-crystal display device of Example 1 in JP-A-10-48420, the alignment film coated with a discotic liquid-crystal molecules-containing optically-anisotropic layer and polyvinyl alcohol in Example 1 in JP-A-9-26572, the 20-inch VA-mode liquid-crystal display device of FIG. 2 to 9in JP-A-2000-154261, and the 20-inch OCB-mode liquid-crystal display devices of FIGS. 10 to 15 in JP-A-2000-154261, then good liquid-crystal display devices with no light leakage were obtained.

### 4. Construction of Low-Refractivity Film:

According to Example 47 in Hatsumei Kyokai Disclosure Bulletin (No. 2001-1745), the stretched cellulose acylate film of the invention was used in construction of low-refractivity films, and the films had good optical properties.

The low-refractivity film of the invention was stuck to the outermost surface layer of the liquid-crystal device of Example 1 in JP-A-10-48420, the 20-inch VA-mode liquid-crystal display device of FIGS. 2 to 9 in JP-A-2000-154261, and the 20-inch OCB-mode liquid-crystal display device of FIGS. 10-15 in JP-A-2000-154261, and the devices were tested. They were all good.

### INDUSTRIAL APPLICABILITY

The invention has made it possible to significantly reduce the polarizing minor impurities even in cellulose acylate film produced according to a melt film formation method.

As a result, the cellulose acylate film of the invention has solved the problems of display trouble (light leakage, bright point impurities, black impurities, yellowing) when it is fitted into liquid-crystal display devices and when the devices are at the time of black level of display.

1. A cellulose acylate film formed through melt casting, in which the number of polarizing minor impurities is from 0 to 10/mm² and the number of black impurities is from 0 to 10/mm², and which has a transmittance at 450 nm (T450) of from 90 to 100%.

2. The cellulose acylate film according to claim 1, in which the number of polarizing minor impurities is from 0 to 8/mm² and the number of black impurities is from 0 to 8/mm², and which has a transmittance at 450 nm (T450) of from 91 to 99%.

3. The cellulose acylate film according to claim 1, which has Rth of from 100 to 800 nm.

4. The cellulose acylate film according to claim 1, which has Rth of from 140 to 500 nm.

5. The cellulose acylate film according to claim 1, wherein the acyl group of the cellulose acylate film satisfies all the requirements of the following formulae (1) to (3):
2.6≦X+Y<3.0, (1)
0≦X≦1.8, (2)
1.0≦Y<3; (3)
wherein, in the above formulae (1) to (3), X means a substitution degree for an acetyl group; Y means a total substitution degree for a propionyl group, a butyryl group, a pentanoyl group and a hexanoyl group.

6. The cellulose acylate film according to claim 1, wherein the acyl group of the cellulose acylate film satisfies all the requirements of the following formulae (4) to (9):
when at least ½ of the following Y is a propionyl group,
2.6≦X+Y≦2.95, (4)
0≦X≦0.95, (5)
1.5≦Y≦2.95; (6)
when less than ½ of the following Y is a propionyl group,
2.6≦X+Y≦2.95, (7)
0.1≦X≦1.65, (8)
1.3≦Y≦2.5; (9)
wherein, in the above formulae (4) to (9), X means a substitution degree for an acetyl group; Y means a total substitution degree for a propionyl group, a butyryl group, a pentanoyl group and a hexanoyl group.

7. The cellulose acylate film according to claim 1, which has Re of from 20 to 300 nm.

8. The cellulose acylate film according to claim 1, which has Re of from 30 to 250 nm.

9. A cellulose acylate film, which is produced by stretching the cellulose acylate film of claim 1 by from 10 to 300% in at least one direction thereof.

10. The cellulose acylate film according to claim 1, which has a total light transmittance of at least 80%.

11. A method for producing cellulose acylate pellets, which comprises kneading and melting a cellulose acylate-containing composition in a kneading extruder, at from 150 to 220° C., at a screw revolution of from 100 to 800 rpm, for a residence time of from 5 seconds to 3 minutes.

12. The method for producing cellulose acylate pellets according to claim 11, wherein the cellulose acylate satisfies all the requirements of the following formulae (1) to (3):
2.6≦X+Y<3.0, (1)
0≦X≦1.8, (2)
1.0≦Y<3; (3)
wherein, in the above formulae (1) to (3), X means a substitution degree for an acetyl group; Y means a total substitution degree for a propionyl group, a butyryl group, a pentanoyl group and a hexanoyl group.

13. The method for producing cellulose acylate pellets according to claim 11, wherein the composition is kneaded and melted in vacuum degasification.

14. The method for producing cellulose acylate pellets according to claim 11, wherein, after melted, the composition is solidified in strands in warm water at 30 to 90° C., and then cut and dried.

15. Cellulose acylate pellets produced according to the method of claim 11.

16. Cellulose acylate pellets which satisfy all the requirements of the following formulae (1) to (3) and in which the number of polarizing minor impurities is from 0 to 100/mm³:
2.6≦X+Y<3.0, (1)
0≦X≦1.8, (2)
1.0≦Y<3; (3)
wherein, in the above formulae (1) to (3), X means a substitution degree for an acetyl group; Y means a total substitution degree for a propionyl group, a butyryl group, a pentanoyl group and a hexanoyl group.

17. A method for producing a cellulose acylate film, which comprises melting the cellulose acylate pellets produced according to the method of claim 11, extruding the melt through a die and forming it into a film having a predetermined thickness on a casting drum, and in which the film formation is so planned that the ratio of the lip distance T of the die to the formed film thickness D (T/D) could be from 2 to 10.

18. A polarizer having a polarizing layer, and, as provided on the polarizing layer, at least one layer of the cellulose acylate film of claim 1.

19. An optical compensatory film for liquid-crystal display panels, which comprises the cellulose acylate film of claim 1 as the substrate thereof.

20. An antireflection film, which comprises the cellulose acylate film of claim 1 as the substrate thereof.
